(19) United States
(12) Patent Application Publication
(10) Pub. No.: US 2013/0114136 A1
(43) Pub. Date: May 9, 2013

(54) PHASE DIFFERENCE FILM LAYERED BODY USED IN STEREOSCOPIC IMAGE DEVICE

(71) Applicants: Masakazu Saito, Tokyo (JP); Manabu Haraguchi, Tokyo (JP); Kentaro Tamura, Tokyo (JP); Hiromasa Hashimoto, Tokyo (JP)

(72) Inventors: Masakazu Saito, Tokyo (JP); Manabu Haraguchi, Tokyo (JP); Kentaro Tamura, Tokyo (JP); Hiromasa Hashimoto, Tokyo (JP)

(73) Assignee: ZEON CORPORATION, Tokyo (JP)

(21) Appl. No.: 13/810,605

(22) PCT Filed: Jul. 14, 2011
(86) PCT No.: PCT/JP2011/066151

§ 371 Date: Jan. 16, 2013

(30) Foreign Application Priority Data
Jul. 20, 2010 (JP) 2010-163359

(51) Int. Cl. G02B 27/26; G02B 5/30

(52) U.S. Cl. CPC G02B 27/26; G02B 5/3083; G02B 5/3016
USPC 359/465; 359/486.01; 349/194

(57) ABSTRACT

A phase difference film stacked body having a lengthy shape, including a first phase difference film that has a uniform phase difference within a plane, and a second phase difference film that includes a plurality of regions that are patterned within a plane, the plurality of regions having different phase differences; as well as a polarizing plate complex having the same, a display device, and polarization glasses corresponding thereto.

### FIELD

The present invention relates to a phase difference film stacked body for use in a display device that is used for three-dimensional display, and more particularly to a patterned phase difference film stacked body for use in a so-called passive type system in which two areally-divided images are formed in respective different polarization states. The present invention also relates to a combination system of a display device that uses the phase difference film stacked body of the present invention with glasses used to observe the display device, and the configuration of a phase difference film stacked body used in the glasses.

### BACKGROUND

As is well known, display devices that can provide both three-dimensional image display and flat image display have been rapidly developed in recent years. As disclosed in Patent Literatures 1 and 2, such display devices are broadly classified into those of passive type and of active type. The passive type system has to simultaneously display an image for the right eye and an image for the left eye within the same screen and distribute the images to the right and left eyes, respectively, using dedicated glasses. For that purpose, a phase difference film that is patterned (referred to hereinbelow as a patterned phase difference film) such as described in Patent Literature 3 is required for creating images of respective different polarization states in positions corresponding to the right and left images on the surface of the display device. In order to surely distribute the images for the right eye and the left eye having different polarization states, simultaneously emitted from the patterned phase difference film, to the right and left eyes on the observer's side, the directions of the transmission axes of polarizing plates, which are used in polarization glasses so as to transmit light of either one polarization state alone, and their combinations with phase difference films are usually changed between the right and left lens openings of the polarization glasses.

As for a method for manufacturing a patterned phase difference film, there has already been known a method wherein the heating temperature of a polymerizable liquid crystal layer is changed stepwise to create different phase states by a method such as described in Patent Literature 4, and then the orientation state is fixed in each stage by a technique such as ultraviolet curing. However, as described in Patent Literature 5, patterned phase difference films to be placed on the surface of a display device are produced on a glass substrate as sheet pieces, and thus do not have sufficient productivity or cost efficiency. Patent Literature 3 discloses a method wherein a plurality of grooves are formed in a substrate, and a liquid crystal material is then applied onto the surface thereof, for polymerization and patterning. Such a method requires a mold for forming the grooves on the substrate. Therefore this method requires a large number of processes, and is not sufficiently economical. Moreover, it is difficult to obtain sufficient orientation restricting force, and an uneven state may occur. In continuous production, a scratch in the processing surface may cause defects. It is therefore difficult to industrially manufacture a patterned phase difference film having a lengthy shape, and it has not been realized to combine it with other optical members to obtain a patterned phase difference film stacked body having a lengthy shape.

### CITATION LIST

### Patent Literature

Patent Literature 1: Japanese Patent Application Laid-Open No. 2004-264338 A (International Publication No. WO 2004/068213, U.S. Patent Application Publication No. 2006/192746)
Patent Literature 2: Japanese Patent Application Laid-Open No. 2005-164916 A
Patent Literature 3: International Publication No. WO 2010/032540 (European Patent Application Publication No. 2239602, U.S. Patent Application Publication No. 2010/073604)
Patent Literature 4: Japanese Patent Application Laid-Open No. 2002-267829 A
Patent Literature 5: Japanese Patent Application Laid-Open No. 2005-49865 A

### SUMMARY

### Technical Problem

In view of the aforementioned circumstances, the present invention proposes a configuration and a manufacturing method aimed at continuously producing a phase difference film stacked body having a lengthy shape. The present invention also proposes a configuration of polarization glasses and a combination thereof with a display device which, even when there are different wavelength dispersion properties of right and left images formed on a display device, can compensate such difference, to realize clear observation of a three-dimensional image.

### Solution to Problem

Means for solving the aforementioned problem are as follows:

(1) A phase difference film stacked body having a lengthy shape, comprising: a first phase difference film that has a uniform phase difference within a plane; and a second phase difference film that includes a plurality of regions that are patterned within a plane, the plurality of regions having different phase differences.
(2) The phase difference film stacked body according to (1), wherein the first phase difference film has a slow axis that is not parallel to a lengthwise direction of the film.
(3) The phase difference film stacked body according to. (1) or (2), wherein the first phase difference film generates a phase difference of approximately λ/4 of light perpendicularly passing through a surface of the film.
(4) The phase difference film stacked body according to any one of (1) to (3), wherein the first phase difference film has a stretch axis that is not parallel to a lengthwise direction of the film.
(5) The phase difference film stacked body according to any one of (1) to (3), wherein the first phase difference film is a liquid crystal resin layer having a slow axis that is not parallel to a lengthwise direction of the film.
(6) The phase difference film stacked body according to any one of (1) to (5), wherein the second phase difference film is formed by applying a liquid crystal layer forming composition onto a substrate that has been subjected to an orientation treatment in parallel to a lengthwise direction of the film.
(7) The phase difference film stacked body according to any one of (1) to (6), wherein: the second phase difference film includes at least a first region and a second region having different phase differences; the first region allows incident polarized light to emit without substantially changing a polarization state thereof; and the second region allows incident polarized light to emit as light polarized in a direction orthogonal to that of the incident polarized light.
(8) The phase difference film stacked body according to any one of (1) to (6), wherein: the second phase difference film includes at least a first region and a second region having different phase differences; the first region allows incident polarized light to emit without substantially changing a polarization state thereof; and the second region allows incident circularly polarized light to emit as light having a substantially reversed rotational direction.
(9) The phase difference film stacked body according to any one of (1) to (8), wherein the first phase difference film and the second phase difference film are arranged in this order from a light source side.
(10) The phase difference film stacked body according to any one of (1) to (8), wherein the second phase difference film and the first phase difference film are arranged in this order from a light source side.
(11) The phase difference film stacked body according to any one of (1) to (10), wherein the first phase difference film and the second phase difference film are stacked via a sticky layer or an adhesive layer.
(12) A polarizing plate complex comprising the phase difference film stacked body according to any one of (1) to (11) and a polarizing plate.
(13) A display device including a display region for the right eye and a display region for the left eye, comprising:

a cut article of the phase difference film stacked body according to (7) or (8),

the cut article of the phase difference film stacked body being arranged so that the first region and the second region of the phase difference film stacked body correspond to the display region for the right eye and the display region for the left eye, respectively.

### Advantageous Effects of Invention

According to the present invention, a patterned phase difference film stacked body for use in a three-dimensional image device can be efficiently and continuously obtained at low cost. In addition, it is possible to realize polarization glasses and an observation method which, even when there are different wavelength dispersion properties and viewing angle characteristics of light emitted from the display device side for right and left images, can compensate such difference, to realize clear observation of a three-dimensional image.

### BRIEF DESCRIPTION OF DRAWINGS

FIG. 1 is a cross-sectional view schematically showing an example of the configuration of a second phase difference film.

FIG. 2 is a perspective view schematically showing the example of the configuration of the second phase difference film shown in FIG. 1.

FIG. 3 is a cross-sectional view schematically showing an example of the configuration of the second phase difference film.

FIG. 4 is a cross-sectional view schematically showing an example of the configuration of the second phase difference film.

FIG. 5 is a cross-sectional view schematically showing an example of the configuration of the second phase difference film.

FIG. 6 is a perspective view schematically showing the example of the configuration of the second phase difference film showing in FIG. 5.

FIG. 7 is a cross-sectional view schematically showing an example of the configuration of the second phase difference film.

FIG. 8 is a cross-sectional view schematically showing an example of the configuration of the second phase difference film.

FIG. 9 is a view schematically showing an example of the configuration of the second phase difference film.

FIG. 10 is a view schematically showing an example of the configuration of the second phase difference film.

FIG. 11 is a view schematically showing an example of the configuration of the second phase difference film.

FIG. 12 is a view schematically showing an example of the configuration of the second phase difference film.

FIG. 13 is a view schematically showing an example of the configuration of the second phase difference film.

FIG. 14 is a view schematically showing an apparatus for manufacturing a second phase difference film.

FIG. 15 is a view schematically showing an apparatus for manufacturing a second phase difference film.

FIG. 16 is a view schematically showing an apparatus for manufacturing a second phase difference film.

FIG. 17 is a view schematically showing an apparatus for manufacturing a second phase difference film.

FIG. 18 is a cross-sectional view schematically showing an example of the configuration of a phase difference film stacked body.

FIG. 19 is a cross-sectional view schematically showing an example of the configuration of the phase difference film stacked body.

FIG. 20 is a cross-sectional view schematically showing an example of the configuration of the phase difference film stacked body.

FIG. 21 is a cross-sectional view schematically showing an example of the configuration of the phase difference film stacked body.

FIG. 22 is a cross-sectional view schematically showing an example of the configuration of the phase difference film stacked body.

FIG. 23 is a view showing an example of arrangement when a phase difference film stacked body according to the present invention is used as a three-dimensional image device.

FIG. 24 is a view showing an example of arrangement when a phase difference film stacked body according to the present invention is used as a three-dimensional image device.

FIG. 25 is a view showing an example of arrangement when a phase difference film stacked body according to the present invention is used as a three-dimensional image device.

FIG. 26 is a view showing an example of arrangement when a phase difference film stacked body according to the present invention is used as a three-dimensional image device.

FIG. 27 is a cross-sectional view showing an example of the configuration of a complex of a phase difference film stacked body and a polarizing plate.

FIG. 28 is a cross-sectional view showing an example of the configuration of a complex of a phase difference film stacked body and a polarizing plate.

FIG. 29 is a cross-sectional view showing an example of the configuration of a complex of a phase difference film stacked body and a polarizing plate.

FIG. 30 is a cross-sectional view showing an example of the configuration of a complex of a phase difference film stacked body and a polarizing plate.

FIG. 31 is a cross-sectional view showing an example of the configuration of a complex of a phase difference film stacked body and a polarizing plate.

FIG. 32 is a schematic view for explaining the mechanism of a three-dimensional image device.

FIG. 33 is a schematic view for explaining the mechanism of a three-dimensional image device.

FIG. 34 is a schematic view for explaining the mechanism of a three-dimensional image device.

FIG. 35 is a schematic view for explaining the mechanism of a three-dimensional image device.

### DESCRIPTION OF EMBODIMENTS

<First Phase Difference Film>

A first phase difference film used in the present invention is a film having a uniform phase difference within the plane. Examples of such a phase difference film may include films made of a stretched polymer such as those described in Japanese Patent Application Laid-Open No. Hei. 5-2108 A, films of a liquid crystal application type such as those described in Japanese Patent Application Laid-Open No. 2003-177242 A, and films having structural birefringence properties such as those described in Japanese Patent Application Laid-Open No. 2006-51796 A. Of these, the films made of a stretched polymer have the best economical efficiency. Those having a stretch axis that is not parallel to the lengthwise direction of the film are preferable. In particular, diagonally stretched films described in Japanese Patent Application Laid-Open Nos. 2003-342384 A and 2007-90532 A are effective. A combination of diagonally stretched films such as those described in WO 2003/102639 may be appropriately used as well. A film of a liquid crystal application type having a slow axis that is not parallel to the lengthwise direction of the film may be used if it is economically feasible. An example thereof is a liquid crystal resin layer whose orientation state is fixed in a diagonally oriented state by using a manufacturing method described in Japanese Patent Application Laid-Open No. 2000-66192 A with an orientation film and an orientation method which are appropriately selected.

In the present application, a liquid crystal resin layer (also simply referred to as a “liquid crystal layer”) refers to a layer obtained by a process wherein a layer of a material that contains a resin in a liquid crystal state is cured while maintaining the molecular orientation thereof.

In the present application, that a film has a uniform phase difference “within the plane” of the film refers to that the phase difference in the film's entire area that is subjected to optical applications is uniform.

That the phase difference is “uniform” within the plane refers to that the distribution of phase difference occurring within the plane is uniform. Specifically, in-plain phase difference thereof that occurs when light at the wavelength of 550 nm perpendicularly passes through the film surface may be within the range of ±65 nm, preferably ±30 nm, and more preferably ±10 nm from ¼ the center value, or within the range of ±65 nm, preferably ±30 nm, and more preferably ±10 nm from ¾ the center value of the wavelength range of the light passing therethrough.

It is preferable that the first phase difference film having a uniform phase difference within the plane also has uniformity within the plane as to wavelength dependence of the phase difference and viewing angle characteristics.

In the first phase difference film, variations of the orientation angle of the slow axis within the plane are preferably ±30%, and more preferably ±20% of the mean orientation angle. The first phase difference film preferably has a mean orientation angle of 45° or 135° with respect to the lengthwise direction of the film.

The first phase difference film preferably has a wavelength dispersion value of 1.25 or less, more preferably 1.20 or less, and particularly preferably 1.15 or less. The wavelength dispersion value indicates the relative ratio of the phase difference within the plane at the wavelength of 550 nm and the phase difference within the plane at the reference wavelength of 400 nm, of the light that perpendicularly passes through the film surface. With the wavelength dispersion ratio in the aforementioned range, the light passing therethrough can be converted into polarized light of even higher uniformity, whereby coloring of the frontal hue of the display device can be suppressed. Such a wavelength dispersion value can be achieved by using, e.g., a cyclic olefin random multicomponent copolymer described in Japanese Patent Application Laid-Open No. Hei. 05-310845 A, a hydrogenated polymer described in Japanese Patent Application Laid-Open No. Hei. 05-97978 A, or a thermoplastic dicyclopentadiene ring-opening polymer or its hydrogenated polymer described in Japanese Patent Application Laid-Open No. Hei. 11-124459 A as the material of the stretched polymer, or by appropriately using a method of combining a plurality of films of stretched polymer or phase difference films of a liquid crystal application type such as those described in WO 2003/102639 and Japanese Patent Application Laid-Open No. 2003-177242 A, etc. As for the viewing angle characteristics, the refractive index anisotropy of the material for use and the combination of a plurality of phase difference films may be selected as described in Japanese Patent Application Laid-Open No. 2002-40258 A.

As the resin for the stretched polymer, thermoplastic resins having favorable transparency may be appropriately selected and used. Examples of such thermoplastic resins may include linear olefin-based polymer resins, alicyclic olefin-based polymer resins, polycarbonate-based resins, polyester-based resins, polysulfone-based resins, polyether sulfone-based resins, polystyrene-based resins, polyolefin-based resins, polyvinyl alcohol-based resins, cellulose acetate-based resins, polyvinylchloride-based resins, and polymethacrylate-based resins. Of these, linear olefin-based polymer resins and alicyclic olefin-based polymer resins are preferred.

If the first phase difference film is an article of a thermoplastic resin formed in a shape of a film, it is preferable that the first phase difference film has a low humidity expansion coefficient in view of size stability. It is preferable that the thermoplastic resin has a humidity expansion coefficient of usually 1×10⁻⁵% RH or less, and preferably 5×10⁻⁶% RH or less. The humidity expansion coefficient may be measured with a film sample that has been cut out in conformity with a test piece type 1B described in JIS K7127 with the width direction as the measurement direction, using a tensile tester with a constant temperature−constant humidity bath (for example, one from Instron). Upon measurement, the humidity is maintained at 35% RH (in a nitrogen atmosphere at 23° C.) or 70% RH (in a nitrogen atmosphere at 23° C.), and the lengths of the respective samples are measured. The humidity expansion coefficient can be calculated by the equation described below. The measurement direction is the lengthwise direction of the cut samples. Measurement is performed five times, and the mean value thereof is taken as the humidity expansion coefficient:

Humidity expansion coefficient=(L70−L35)/(L35×ΔH),

(wherein 135: the length (mm) of the sample at 35% RH, L70: the length (mm) of the sample at 70% RH, and ΔH: 35% (=70%−35%) RH.

As the thermoplastic resin for providing a film that satisfies such characteristics, alicyclic olefin-based polymers are particularly preferable. If the humidity expansion coefficient is not more than the aforementioned value, deformation of the film due to moisture absorption can be avoided. This can prevent curling due to cure shrinkage when another layer is formed thereon by irradiation with, e.g., ultraviolet rays. When such a film is pasted to another optical member such as a polarizing plate, the absence of the film expansion due to moisture absorption facilitates positioning for pasting. When the film is pasted to another member of a display device for use, the same material as the material used for optical compensation films of that member may be used, whereby the warpage of the panel can be ameliorated and stable image can be provided.

In order to prevent the occurrence of deformation or stress during use at a high temperature, the resin material constituting the first phase difference film preferably has a glass transition temperature (measured by differential scanning calorimetry (DSC)) of not less than 80° C., and more preferably in the range of 100° C. to 250° C.

Examples of the liquid crystal compounds that may be used for preparing the first phase difference film of the liquid crystal application type may include rod-shaped liquid crystal compounds having a polymerizable group, and side chain type liquid crystal polymer compounds. Examples of the rod-shaped liquid crystal compounds for use may include publicly known rod-shaped crystal compounds having a polymerizable group such as those described in Japanese. Patent Application Laid-Open Nos. 2002-030042 A, 2004-204190 A, 2005-263789 A, 2007-119415 A, and 2007-186430 A. Examples of the side chain type liquid crystal polymer for use may include side chain type liquid crystal polymer compounds such as those described in Japanese Patent Application Laid-Open No. 2003-177242 A. As the liquid crystal compound, one species thereof may be used alone, or two or more thereof may be used in combination in arbitrary proportions.

The first phase difference film preferably has a slow axis at approximately 45° with respect to the lengthwise direction. Approximately 45° herein refers to the range of ±10°, and more preferably ±5° with respect to the 45° direction. In addition, it is preferable that the first phase difference film is an approximately λ/4 plate. That is, it is preferable that the first phase difference film is capable of generating a phase difference of approximately λ/4 wavelength of the light passing therethrough. Specifically, if the phase difference Re of the first phase difference film falls within the range of usually ±65 nm, preferably ±30 nm, and more preferably ±10 nm from λ/4 of the center value of the wavelength range of the light passing therethrough, then the first phase difference film can be regarded as being capable of generating a phase difference Re that is approximately λ/4 wavelength of the light passing therethrough. Since the light used for image display is usually, visible light, if the aforementioned requirement is satisfied for the wavelength of 550 nm which is the center value of the wavelength range of the visible light, then the phase difference Re of approximately λ/4 wavelength is achieved.

The first phase difference film satisfying such requirements can increase the continuous productivity. Specifically, when such requirements are satisfied, a phase difference film whose anisotropic regions have a slow axis parallel to the lengthwise direction may be employed as the second phase difference film that matches with the first phase difference film. This consequently facilitates the continuous production of the phase difference film stacked body according to the present invention.

The thickness of the first phase difference film may be optimized in view of the final appearance specification of the display device and for the purpose of resolving the warpage of the panel in cooperation with a optical compensation film used in the display device.

<Second Phase Difference Film>

A second phase difference film used in the present invention is a second phase difference film that includes a plurality of regions that are patterned within the plane, wherein the plurality of regions have different phase differences.

As used herein, “patterned” refers to a mode of repetition at certain regular intervals. That a plurality of regions are “patterned” within a plane refers to that two types or more of regions are arranged to appear repeatedly in the same order when observed along a direction within the plane.

For example, if the intended use of the phase difference film stacked body of the present invention is for a three-dimensional image device of a passive type, it is preferable that the second phase difference film is patterned in stripes of narrow band-shaped regions arranged in parallel, and it is particularly preferable that the second phase difference film is patterned in stripes of narrow band-shaped regions extending in the lengthwise direction, arranged in parallel so that the band-shaped regions appear repeatedly when observed along a direction orthogonal to the lengthwise direction within the plane of the film.

The plurality of regions having different phase differences refer to, e.g., a mode in which there are regions having a phase difference and regions having no phase difference. More specifically, the second phase difference film may be in a mode such that the second phase difference film includes at least a first region and a second region having different phase differences, the first region allows incident polarized light to emit with no substantial change, and the second region allows incident circularly polarized light to emit as light having a substantially reversed rotational direction.

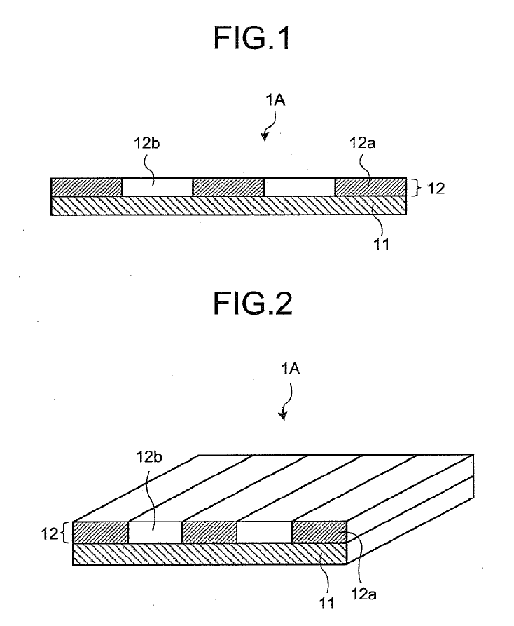

FIGS. 1 and 2 are views schematically showing an example of the second phase difference film (FIG. 1 shows a cross-sectional view of the film shown in FIG. 2).

In the example shown in FIGS. 1 and 2, the second phase difference film 1A includes a substrate 11 and a resin layer 12 provided on the top surface of the substrate 11. The resin layer 12 includes liquid crystal oriented resin regions 12a and isotropic resin regions 12b.

The liquid crystal oriented resin regions 12a are obtained by applying a liquid crystal layer forming composition onto the substrate 11 and curing the composition while the composition is in a liquid crystal phase. The liquid crystal oriented resin regions 12a may be anisotropic regions that show a phase difference of approximately λ/2. In the present application, a phase difference of approximately λ/2 is a capability of generating a phase difference Re of approximately ½ wavelength of the light passing therethrough. Specifically, if the phase difference Re falls within the range of usually ±65 nm, preferably ±30 nm, and more preferably ±10 nm from ½ the center value of the wavelength range of the light passing therethrough, then the region is regarded as being capable of generating the phase difference Re of approximately ½ the wavelength of the light passing therethrough. Since the light used for image display is usually visible light, if the aforementioned requirement is satisfied for the wavelength of 550 nm which is the center value of the wavelength range of the visible light, then the phase difference Re of approximately ½ the wavelength is achieved.

Meanwhile, the isotropic resin regions 12b are obtained by curing liquid crystal molecules while the molecules are in a isotropic phase wherein the molecules are randomly oriented. The isotropic resin regions 12b, i.e. the first regions, allow the incident polarized light to emit without substantially changing the polarization state thereof.

As used herein, “without substantially changing the polarization state” means that if the incident polarized light is linearly polarized, then the light is emitted as linearly polarized light, whereas if the incident polarized light is circularly polarized, then the light is emitted as circularly polarized light. In the present application, with no “substantial” change in the polarization state means that, in the case wherein the light is linearly polarized, the direction of vibrations of the linearly polarized light deviates in angle within the range of less than ±5° with respect to the exact angle of 0°. Errors from the exact angle are preferably less than 4°, more preferably less than 2°, and the most preferably less than 1°. In the case wherein the light is circularly polarized, it means that the ellipticity at the wavelength of 550 nm (phase difference measurement instrument “KOBRA-21ADH” from Oji Scientific Instruments) remains in 0.96-1.0. The ellipticity refers to the ratio of the minor axis to the major axis of the elliptic polarization (minor axis/major axis). An ellipticity=1 represents circular polarization. An ellipticity=0 represents linear polarization. “Substantially” reversing the rotational direction of circularly polarized light means that, e.g., there is a phase difference as large as approximately λ/2 of the light passing therethrough, and the phase difference falls within the range of usually ±65 nm, preferably ±30 nm, and more preferably ±10 nm from ½ the center value of the wavelength range of the light passing therethrough, whereby polarized light orthogonal to the incident polarized light is emitted. In this example, the liquid crystal oriented resin regions 12a and the isotropic resin regions 12b have materialistic continuity, and this example is therefore distinguished from discontinuous examples such as those having gaps therebetween.

The liquid crystal layer forming composition may be applied onto the substrate by using a publicly known method such as reverse gravure coating, direct gravure coating, die coating, and bar coating. The thickness of the resin layer may be appropriately adjusted so as to have a desired thickness after curing. The thickness of the resin layer depends on a Δn value of the liquid crystal compound in use, or, if the liquid crystal layer forming composition includes two or more liquid crystal compounds, depends on a Δn value that is determined from the refractive index anisotropy Δn values and the containing ratio of the respective liquid crystal compounds. A thickness of 0.5 to 50 μm is preferred. Surface treatment such as corona treatment may be applied onto the substrate. Rubbing orientation treatment, which will be described later, may also be applied.

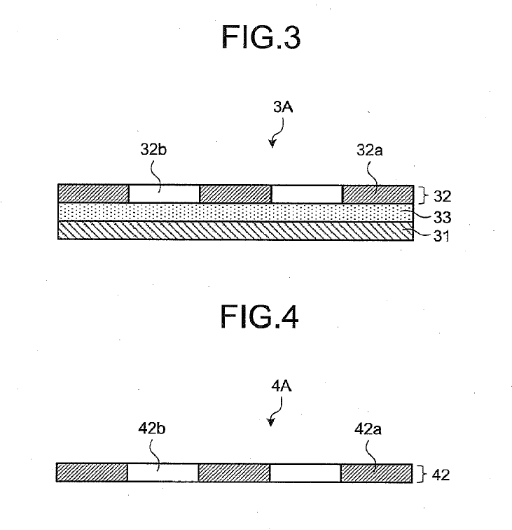

FIG. 3 is a cross-sectional view schematically showing another example of the second phase difference film. The example shown in FIG. 3 shows a mode further including an orientation film 33 in addition to the components of the second phase difference film shown in FIG. 1. In this example, the second phase difference film 3A includes a substrate 31, the orientation film 33 provided on the top surface of the substrate 31, and a resin layer 32 provided on the top surface of the orientation film 33. The resin layer 32 includes liquid crystal oriented resin regions 32a and isotropic resin regions 32b. Also in this example, the liquid crystal oriented resin regions 32a and the isotropic resin regions 32b have materialistic continuity, and this example is therefore distinguished from discontinuous examples such as those having gaps therebetween.

FIG. 4 is a cross-sectional view schematically showing still another example of the second phase difference film. In the example shown in FIG. 4, the second phase difference film 4A consists of a resin layer 42 alone. The resin layer 42 includes liquid crystal oriented resin regions 42a and isotropic resin regions 42b. This example shows a mode wherein the resin layer 12 of the second phase difference film shown in FIG. 1 is peeled off the substrate and the resin layer alone is used as a second phase difference film.

“Different phase differences” usually mean that there is a difference between phase differences between the slow axes and fast axes. For the second phase difference film, “different phase differences” are more broadly interpreted to cover the difference in the degrees of changing the polarization state of incident polarized light. For example, the second phase difference film may be in a mode such that the second phase difference film includes at least first regions and second regions having different phase differences, the first regions allow the incident polarized light to emit without substantially changing the polarization state thereof, and the second regions allow incident polarized light to emit as light polarized in a direction orthogonal to that of the incident polarized light.

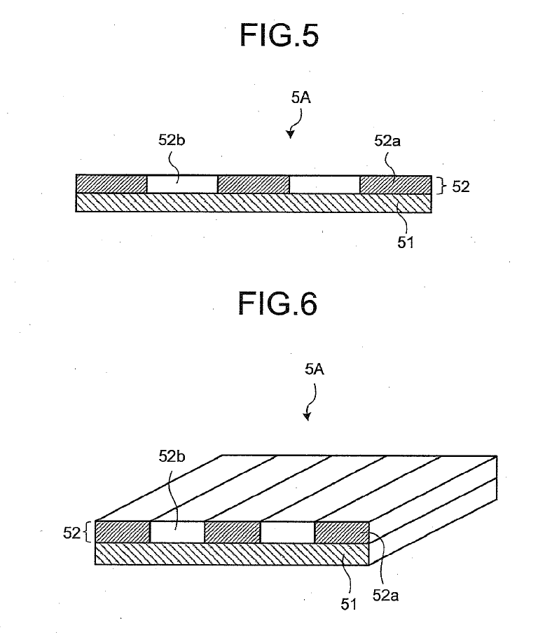

FIGS. 5 and 6 are views schematically showing an example of the second phase difference film in such a mode (FIG. 5 is a cross-sectional view of FIG. 6).

In the example shown in FIGS. 5 and 6, the second phase difference film 5A includes a substrate 51 and a resin layer 52 provided on the top surface of the substrate 51. The resin layer 52 includes twisted nematic (TN) regions 52a and isotropic resin regions 52b. The twisted nematic regions 52a are regions that rotate linearly polarized light by 90°. The isotropic resin regions 52b are regions wherein the resin has been cured while the liquid crystal molecules are in a randomly oriented state. The twisted nematic regions may be obtained by fixing liquid crystal molecules in a twisted nematic phase.

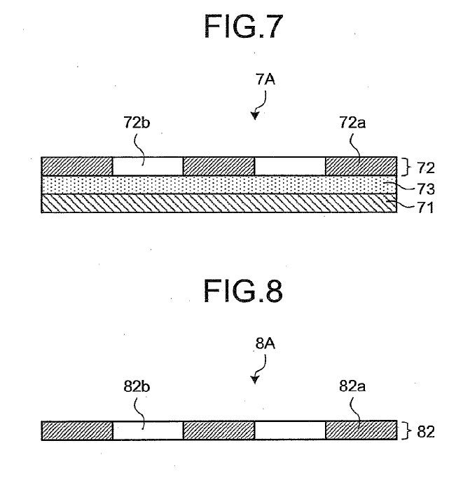

FIG. 7 shows an example of a mode further including an orientation film 73 in addition to the components of the second phase difference film shown in FIG. 5. In the example, the second phase difference film 7A includes a substrate 71, the orientation film 73 provided on the top surface of the substrate 71, and a resin layer 72 provided on the top surface of the orientation film 73. The resin layer 72 includes twisted nematic regions 72a and isotropic resin regions 72b.

In an example shown in FIG. 8, the second phase difference film 8A consists of a resin layer 82 alone. The resin layer 82 includes twisted nematic regions 82a and isotropic resin regions 82b. This example shows a mode wherein the resin layer 52 of the second phase difference film shown in FIG. 5 is peeled off the substrate and the resin layer is used alone as a second phase difference film.

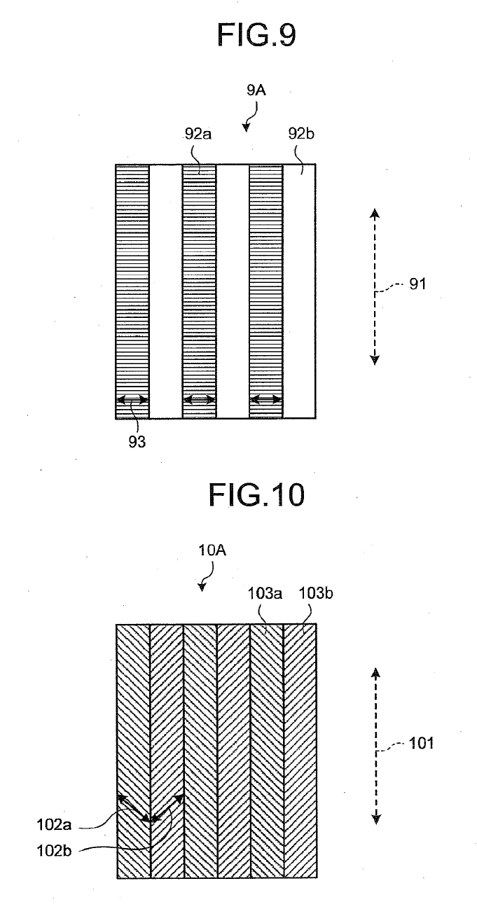

In the examples shown in FIGS. 1 to 4 and the examples shown in FIGS. 5 to 8, the liquid crystal oriented resin regions or twisted nematic regions showing a phase difference of approximately λ/2 may be oriented by an orientation treatment approximately in parallel with the lengthwise direction (for example, a rubbing treatment that is performed on the surface that directly contacts with the resin layer, approximately in parallel with the lengthwise direction). Such a treatment enables continuous production. In the present application, that two directions are “approximately” parallel or “approximately” orthogonal refers to that the directions form an angle in the range of ±10°, and preferably ±5° from the parallel or orthogonal direction. In an instance wherein the second phase difference film includes liquid crystal oriented resin regions showing a phase difference of approximately λ/2, when the orientation treatment to the orientation film is performed in a direction that is approximately parallel to the lengthwise direction, the molecules in the liquid crystal oriented resin regions showing the phase difference of approximately λ/2 are also usually oriented in the direction that is approximately parallel to the lengthwise direction. However, the orientation treatment in the present invention is not limited thereto. For example, the present invention may include an embodiment such as the one shown in FIG. 9 wherein the slow axes of the liquid crystal oriented resin regions are oriented in a direction orthogonal to the lengthwise direction. Even in such a case, continuous production is possible if the orientation treatment is performed approximately in parallel with the lengthwise direction. In the example shown in FIG. 9, the second phase difference film 9A includes a resin layer that includes liquid crystal oriented resin regions 92a and isotropic resin regions 92b arranged in parallel. In this example, the rubbing direction 91 of the layer in direct contact with the resin layer is parallel to the lengthwise direction of the film, and the slow axes 93 of the liquid crystal oriented resin regions 92a oriented thereby is in a direction orthogonal to the rubbing direction 91. Such orientation can be implemented, e.g., by a method of using a special orientation film material that produces an orientation restricting force in a direction orthogonal to the direction of the orientation treatment such as those described in Japanese Patent Application Laid-Open Nos. 2002-62427 A and 2002-268068 A.

It is also possible to employ an embodiment as shown in FIG. 10 wherein twisted nematic regions that rotate light by 45° in opposite twisting directions are alternately arranged. For example, in the example shown in FIG. 10, the second phase difference film 10A includes a resin layer that includes twisted nematic regions 103a and 103b arranged in parallel. In this example, the rubbing direction 101 of the layer in direct contact with the resin layer is parallel to the lengthwise direction of the film. The regions 103a and 103b oriented thereby can rotate polarized light in the directions shown by the arrows 102a and 102b, respectively. Also in this case, an orientation film having a property of providing an orientation restricting force parallel to or orthogonal to the orientation may be appropriately selected so that the direction of the orientation treatment becomes parallel to the lengthwise direction.

As the liquid crystal compound useful for forming the second phase difference film, it is possible to use the same compounds as the liquid crystal compounds used for the aforementioned phase difference film of a liquid crystal application type. As the liquid crystal compound, one species thereof may be used alone, or two or more thereof may be used in combination in arbitrary proportions. Examples of useful polymerizable liquid crystal compounds for use may include those commercially available such as “LC242” from BASF SE. The liquid crystal compounds preferably have a Δn value of not less than 0.05 and not more than 0.30, and more preferably not less than 0.10 and not more than 0.25. The Δn value may be measured by the Senarmont method. As used herein, the Δn value of the liquid crystal compound(s) refers to, if the liquid crystal layer forming composition includes only one type of liquid crystal compound, the Δn value of the liquid crystal compound, and, if the liquid crystal layer forming composition includes two or more types of liquid crystal compound, a Δn value determined from the Δn values and the containing ratio of the respective liquid crystal compounds. If the Δn value is less than 0.05, necessary thickness of the resin layer for obtaining a desired optical function increases. This lowers the orientation uniformity and is disadvantageous in terms of economic costs, thus being undesirable. If the Δn value is not less than 0.30, necessary thickness of the resin layer for obtaining a desired optical function decreases. This is disadvantageous in terms of thickness precision, and the absorption edge on the long wavelength side of the ultraviolet absorption spectrum may possibly reach the visible range. Such a resin layer is nevertheless usable unless the absorption edge of the spectrum reaching the visible range adversely affects the desired optical performance.

The liquid crystal layer forming composition for forming the second phase difference film may appropriately contain an organic solvent, a surfactant, a chiral agent, a polymerization initiator, a ultraviolet absorber, a cross-linking agent, an antioxidant, and the like in order to impart appropriate physical properties for the manufacturing method and the properties of the final products.

Examples of suitable organic solvent may include ketones, alkyl halides, amides, sufloxides, hetero ring compounds, hydrocarbons, esters, and ethers. Of these, cyclic ketones and cyclic ethers are preferable since they easily dissolve polymerizable liquid crystal compounds. Examples of the cyclic ketone solvent may include cyclopropanone, cyclopentanone, and cyclohexanone. Of these, cyclopentanone is preferred. Examples of the cyclic ether solvent may include tetrahydrofuran, 1,3-dioxolane, and 1,4-dioxane. Of these, 1,3-dioxolane is preferred. As the solvent, one species thereof may be used alone, or two or more thereof may be used in combination in arbitrary proportions. The solvent is preferably optimized in view of compatibility, viscosity, and surface tension of the liquid crystal layer forming composition. The containing ratio of the organic solvent in the liquid crystal layer forming composition may be 30% to 95% by weight with respect to the total amount of solid content other than the organic solvent.

As the surfactant, those which do not interfere with orientation may be appropriately selected. Examples of surfactant that can be suitable used may include nonionic surfactants containing siloxane and an alkyl fluoride group as hydrophobic groups. Of these, oligomers having two or more hydrophobic groups per molecule are particularly suitable. Examples of such a surfactant may include PolyFox PF-151N, PF-636, PF-6320, PF-656, PF-6520, PF-3320, PF-651, and PF-652 from OMNOVA Solutions Inc.; FTERGENT FTX-209F, FTX-208G, and FTX-204D from NEOS COMPANY LTD.; and Surflon KH-40 from Seimi Chemical Co., Ltd. As the surfactant, one species thereof may be used, or two or more thereof may be used in combination in arbitrary proportions. The adding ratio of the surfactant is preferably determined such that the concentration of the surfactant is 0.05% to 3% by weight in the resin layer that is obtained by curing the liquid crystal layer forming composition. If the adding ratio of the surfactant is less than 0.05% by weight, the orientation restricting force at the air interface can decrease to cause an orientation defect. If the adding ratio of the surfactant is more than 3% by weight, on the other hand, an excessive surfactant may break in between molecules of the liquid crystal compound to reduce the orientation uniformity.

The chiral agent may be either a polymerizable compound or a nonpolymerizable, compound. As the chiral agent, those which have a chiral carbon atom in the molecule thereof and do not disturb the orientation of polymerizable liquid crystal compounds may be appropriately selected. As the chiral agent, one species thereof may be used alone, or two or more thereof may be used in combination. Examples of the polymerizable chiral agent compound for use may include commercially available ones (such as “LC756” from BASF SE) as well as publicly known ones such as those described in Japanese Patent Application Laid-Open Nos. Hei. 11-193287 A and 2003-137887 A, although not limited thereto. The chiral agent may be co-used with polymerizable liquid crystal compounds in an instance wherein twisted nematic regions are formed.

As the polymerization initiator, although a thermal polymerization initiator may be used, usually a photopolymerization initiator is used. As the photopolymerization initiator, for example, publicly known compounds that generate a radical or acid upon receiving ultraviolet rays or visible rays may be used. Examples of the photopolymerization initiator may include benzoin, benzyl methyl ketal, benzophenone, biacetyl, acetophenone, Michler's ketone, benzyl, benzyl isobutyl ether, tetramethylthiuram mono(di)sulfide, 2,2-azobisisobutyronitrile, 2,2-azobis-2,4-dimethylvaleronitrile, benzoyl peroxide, di-tert-butyl peroxide, 1-hydroxycyclohexyl phenyl ketone, 2-hydroxy-2-methyl-1-phenyl-propane-1-one, 1-(4-isopropylphenyl)-2-hydroxy-2-methylpropane-1-one, thioxanthone, 2-chlorothioxanthone, 2-methylthioxanthone, 2,4-diethylthioxanthone, methylbenzoylformate, 2,2-diethoxyacetophenone, β-ionone, β-bromostyrene, diazoaminobenzene, α-amyl cinnamic aldehyde, p-dimethylaminoacetophenone, p-dimethylaminopropiophenone, 2-chlorobenzophenone, pp′-dichlorobenzophenone, pp′-bisdiethylaminobenzophenone, benzoin ethyl ether, benzoin isopropyl ether, benzoin n-propyl ether, benzoin n-butyl ether, diphenyl sulfide, bis(2,6-methoxybenzoyl)-2,4,4-trimethyl-penthylphosphine oxide, 2,4,6-trimethylbenzoyldiphenyl-phosphine oxide, bis(2,4,6-trimethylbenzoyl)-phenylphosphine oxide, 2-methyl-1[4-(methylthio)phenyl]-2-morpholinopropane-1-one, 2-benzyl-2-dimethylamino-1-(4-morpholinophenyl)-butane-1-one, anthracene benzophenone, α-chloroanthraquinone, diphenyl disulfide, hexachlorobutadiene, pentachlorobutadiene, octachlorobutene, 1-chloro methylnaphthalene, 1,2-octanedione, 1-[4-(phenylthio)-2-(o-benzoyloxime)], carbazole oxime compounds such as 1-[9-ethyl-6-(2-methylbenzoyl)-9H-carbazol-3-yl]ethanone 1-(o-acetyloxime), (4-methylphenyl)[4-(2-methylpropyl)phenyl]iodonium hexafluorophosphate, 3-methyl-2-butynyl tetramethylsulfonium hexafluoroantimonate, and diphenyl-(p-phenylthiophenyl)sulfonium hexafluoroantimonate. As the polymerization initiator, one species thereof may be used alone, or two or more thereof may be used in combination in arbitrary proportions, depending on the desired physical properties. If necessary, the liquid crystal layer forming composition may further contain a publicly known photosensitizes and a tertiary amine compound as a polymerization promoter, for controlling the curing ability of the liquid crystal layer forming composition. For improving photopolymerization efficiency, it is preferable to appropriately select the mean molar absorption coefficients of the liquid crystal compound, the photopolymerization initiator, and the like.

Examples of the ultraviolet absorber may include: hindered amine-based ultraviolet absorbers such as 2,2,6,6-tetramethyl-4-piperidylbenzoate, bis(2,2,6,6-tetramethyl-4-piperidyl)sebacate, bis(1,2,2,6,6-pentamethyl-4-piperidyl)-2-(3,5,-di-t-butyl-4-hydroxybenzyl)-2-n-butylmalonate, and 4-(3-(3,5-di-t-butyl-4-hydroxypnenyl)propionyloxy)-1-(2-(3-(3,5-di-t-butyl-4-hydroxyphenyl)propionyloxy)ethyl)-2,2,6,6,-tetramethy piperidine; benzotriazole-based ultraviolet absorbers such as 2-(2-hydroxy-5-methylphenyl)benzotriazole, 2-(3-t-butyl-2-hydroxy-5-methylphenyl)-5-chlorobenzetriazole, 2-(3,5-di-t-butyl-2-hydroxyphenyl)-5-chlorobenzotriazole, and 2-(3,5-di-t-amyl-2-hydroxyphenyl)benzotriazole; benzoate-based ultraviolet absorbers such as 2,4-di-t-butylphenyl-3,5-di-t-butyl-4-hydroxybenzoate and hexadecyl-3,5-di-t-butyl-4-hydroxybenzoate; benzophenone-based ultraviolet absorbers; and acrylonitrile-based absorbers. As the ultraviolet absorber, one species thereof may be used alone, or two or more thereof may be used in combination, in order to impart desired light resistance. The adding ratio of the ultraviolet absorber usually falls within the range of 0.001 to 5 parts by weight, and preferably 0.01 to 1 part by weight, with respect to 100 parts by weight of the liquid crystal compound. If the adding ratio of the ultraviolet absorber is less than 0.001 parts by weight, the ultraviolet absorbance may become insufficient to provide desired light resistance. If the adding ratio is more than 5 parts by weight, curing of the liquid crystal layer forming composition with active energy rays to form a resin layer may result in insufficient curing, which unfavorably causes lowered mechanical strength and lowered heat resistance of the resin layer.

The liquid crystal layer forming composition may contain a cross-linking agent depending on desired mechanical strength. Examples of the cross-linking agent may include: polyfunctional acrylate compounds such as trimethylolpropane tri(meth)acrylate, pentaerythritol tri(meth)acrylate, pentaerythritol tetra(meth)acrylate, dipentaerythritol hexa(meth)acrylate, and 2-(2-vinyloxyethoxy)ethyl acrylate; epoxy compounds such as glycidyl (meth)acrylate, ethylene glycol diglycidyl ether, glycerin triglycidyl ether, and pentaerythritol tetraglycidyl ether; aziridine compounds such as 2,2-bishydroxymethyl butanol-tris[3-(1-aziridinyl)propionate], 4,4-bis(ethyleneimino carbonylamino)diphenylmethane, and trimethylolpropane-tri-β-aziridinyl propionate; isocyanate compounds such as hexamethylene diisocyanate and isocyanurate type isocyanates, biuret type isocyanates, and adduct type isocyanates derived from hexamethylene diisocyanate; polyoxazoline compounds having an oxazoline group as a side chain; and alkoxysilane compounds such as vinyltrimethoxysilane, N-(2-aminoethyl)-3-aminopropyltrimethoxysilane, 3-aminopropyltrimethoxysilane, 3-gycidoxypropyltrimethoxysilane, 3-(meth)acryloxypropyltrimethoxysilane, and N-(1,3-dimethylbutylidene)-3-(triethoxysilyl)-1-propaneamine. As the cross-linking agent, one species thereof may be used alone, or two or more thereof may be used in combination in arbitrary proportions. Depending on the reactivity of the cross-linking agent, the liquid crystal layer forming composition may contain a publicly known catalyst for improving productivity in addition to film strength and durability. The adding ratio of the cross-linking agent is preferably determined such that the concentration of the cross-linking agent is 0.1% to 20% by weight in the cured resin that is obtained by curing the liquid crystal layer forming composition. If the adding ratio of the cross-linking agent is less than 0.1% by weight, the effect of improving cross-link density may not be obtained. If the adding ratio is more than 20% by weight, on the other hand, stability of the cured resin layer may be lowered.

The antioxidant include phenol-based antioxidants such as tetrakis(methylene-3-(3,5-di-t-butyl-4-hydroxyphenyl)propionate)methane, phosphorous-based antioxidants, and thioether-based antioxidants. The adding amount of the antioxidant is in a range by which the transparency and stickiness of the sticky layer do not decrease.

When an orientation film is used as means for orienting the liquid crystal layer forming composition on the substrate, the substrate may be covered with cellulose, a silane coupling agent, polyimide, polyamide, polyvinyl alcohol, epoxy acrylate, silanol oligomer, polyacrylonitrile, phenol resins, polyoxazole, cyclized polyisoprene, and the like, although not limited thereto. The orientation film may have a thickness that realizes a desired orientation uniformity of liquid crystal layer. The thickness is preferably 0.001 to 5 μm, and more preferably 0.01 to 2 μm. Examples of other orientation means may include a method of using a photo-orientation film and polarized UV such as those described in Japanese Patent Application Laid-Open No. Hei. 6-289374 A, Japanese Translation of PCT Application No. 2002-507782 A, Japanese Patent Publication Nos. 4267080 B, 4647782 B, and 4022985 B, and U.S. Pat. No. 5,389,698.

The orientation treatment may also be direct rubbing performed onto a surface of an appropriate substrate without using an orientation film. As such a substrate, a transparent resin substrate is usually used. Being transparent refers to, e.g., having a total luminance transmittance of 80% or higher (measured in conformity with JIS K7361-1997 using a haze meter (NDH-300A from Nippon Denshoku Industries Co., Ltd.)) with a thickness of 1 mm.

Specific examples of the transparent resin substrate include single-layered and stacked films made of alicyclic olefin-based polymers, linear olefin-based polymers such as polyethylene and polypropylene, triacetylscellulose, polyvinyl alcohol, polyimide, polyarylate, polyester, polycarbonate, polysulfone, polyethersulfone, modified acrylic polymer, epoxy resin, polystyrene, acrylic resin, and other synthetic resins. Of these, films made of alicyclic olefin-based polymers or linear olefin-based polymers are preferable. Ones made of alicyclic olefin-based polymers are particularly preferred in view of transparency, low moisture absorbency, size stability, and light weight. As the material for the transparent resin substrate, one species thereof may be used alone, or two or more thereof may be co-used in arbitrary combinations and ratio.

If stretched polymer is used as the substrate, the orientation treatment effect may be obtained without performing rubbing treatment. However the orientation treatment effect may also be obtained by a rubbing treatment, a rubbing treatment with an orientation film, or polarized UV irradiation. In view of handling ability in a manufacturing system, material cost, thickness reduction, and weight reduction, the substrate preferably has a thickness of not less than 30 μm and more preferably not less than 60 μm, and preferably not more than 300 μm and more preferably not more than 200 μm.

As an alternative method, the second phase difference film may be firstly formed on a commercially-available inexpensive birefringent substrate, and eventually transferred onto a first phase difference film via a sticky layer or an adhesive layer. Such a method is disclosed in Japanese Patent Application Laid-Open. No. 2010-91616 A. Examples of the sticky agent or adhesive agent used in the sticky layer or adhesive layer may include adhesive agents in a strict sense that lose stickiness at normal temperatures as a result of curing (including hot-melt adhesive agents, UV curable sticky agents, and EB curable sticky agents) and sticky agents that will not lose stickiness (such as a pressure sensitive adhesive agent). Although there is no particular limitation to the selection of the adhesive agents, a highly transparent adhesive agent is usually used. In order to shorten the time of the manufacturing processes, a sticky agent that does not change in physical property immediately after pasting and an adhesive agent that cures quickly (such as hot-melt adhesive agents, UV curable adhesive agents, and EB curable adhesive agents) are preferred. For securing reliability and mechanical strength of the product, a UV curable adhesive agent and an EB curable adhesive agent are particularly preferred. As the adhesive agent, one species thereof may be used alone, or two or more thereof may be used in combination in arbitrary proportions.

The adhesive layer may contain an additive unless the effects are significantly impaired. Examples of the additives may include a light diffusion agent. The light diffusion agent is particles having a property of diffusing light, and broadly classified into inorganic fillers and organic fillers. Examples of the inorganic filler may include glass, silica, aluminum hydroxide, aluminum oxide, titanium oxide, zinc oxide, barium sulfate, magnesium silicate, and mixtures thereof. Examples of the organic filler may include acrylic resin, polyurethane resin, polyvinyl chloride resin, polystyrene resin, polyacrylonitrile resin, polyamide resin, polysiloxane resin, melamine resin, benzoguanamine resin, fluorine resin, polycarbonate resin, silicone resin, polyethylene resin, ethylene-vinyl acetate copolymer, acrylonitrile, and cross-linked compounds thereof. Of such organic fillers, fine powders of acrylic resin, polystyrene resin, polysiloxane resin, and cross-linked products thereof are preferred because of high dispersibility, high heat resistance, and the absence of coloring (yellowing) during molding. Of these, fine powders of cross-linked acrylic resin is more preferred. As the light diffusion agent, those made of two or more species of materials may be used, or two or more light diffusion agents may be used in combination.

The amount of the light diffusion agent is usually 0.5 to 20 parts by weight with respect to 100 parts by weight of solid content that the uncured adhesive agent contains. The specific amount of the light diffusion agent is determined by a desired haze value and the thickness of the adhesive layer. The haze value (measured in conformity with JIS K7361-1 using the “haze meter NDH-300A” from Nippon Denshoku Industries Co., Ltd.) is preferably 3% or less. The thickness of the adhesive layer may be arbitrarily selected unless the optical characteristics, reliability, and mechanical strength are impaired. The thickness is preferably not less than 0.5 μm and more preferably not less than 1 μm, and preferably not more than 100 μm and more preferably not more than 50 μm. Thickness of more than 100 μm may lower the transmittance or cause insufficiency in curing of the adhesive layer, whereby reliability and mechanical strength may be lowered. Thickness of less than 0.5 μm may cause entrainment of air bubbles during the pasting process because of asperities at the surfaces of the members to be pasted. In order to reduce the effect of ultraviolet rays, the layer may contain the aforementioned ultraviolet absorber. The sticky layer or adhesive layer in use preferably has high hardness in view of the abrasion resistance (for example, steel-wool test) and the surface hardness (for example, pencil hardness test) on the surface of the second phase difference film. The layer preferably has a pencil hardness of HB or higher when measured alone.

<Method for Manufacturing Second Phase Difference Film>

The second phase difference film may be formed by applying a liquid crystal layer forming composition onto a surface to form a layer of the liquid crystal layer forming composition, and performing region-specific different curing treatment to the layer.

As described above, the surface onto which the liquid crystal layer forming composition is applied may be the surface of the substrate or the surface of an orientation film formed on the substrate. Prior to applying, an orientation treatment for orienting the liquid crystal compound in the liquid crystal layer forming composition may be performed to the surface if necessary. Examples of such an orientation treatment may include the aforementioned various rubbing treatments. If stretched polymer is employed as the substrate, the liquid crystal compound can be oriented without such an orientation treatment. Examples of the applying method may include the aforementioned publicly known methods.

Examples of the region-specific different curing treatment may include a method that includes orienting the liquid crystal compound in the liquid crystal layer forming composition, performing weak ultraviolet exposure on some of the regions in that state, and then changing the orientation state and performing relatively strong ultraviolet exposure in that state. Another example of the region-specific different curing treatments is a method that includes orienting the liquid crystal compound in the liquid crystal layer forming composition, heating some of the regions in that state for generating difference of the orientation state of the liquid crystal compound in each region, and performing ultraviolet exposure in that state. More specifically, the following methods may be used.

(1) One method uses selective UV exposure. In the case of using UV exposure, selective UV exposure may be performed on the layer of the liquid crystal layer forming composition through a photomask that has light transmitting portions and light shielding portions corresponding to the intended pattern shape, to give a desired pattern to the liquid crystal layer. As the photomask, photomasks of a fixed type and a conveyance type may be used depending on the situation. As used herein, the fixed type photomask refers to one that is installed on a process line in a fixed manner, whereas the conveyance type photomask refers to one having a form of a lengthy film that can be conveyed over a process line. The conveyance type photomask may also serve as a substrate that is subjected to applying of the liquid crystal layer forming composition. That is, the liquid crystal layer forming composition is applied onto one side of the photomask to form a layer, and UV irradiation is performed onto the other side of the photomask, for effecting selective UV exposure. The light shielding portions of the photomask may be formed by using techniques such as a resist and printing. Printing techniques such as a die, gravure, inkjet, screen, and rotary screen may be appropriately used. The method for forming a pattern by using a photomask may be designed in accordance with the intended final width and the magnification that is univocally determined by the distance between the photomask and the liquid crystal layer, the light distribution characteristic of the light source for use, etc.

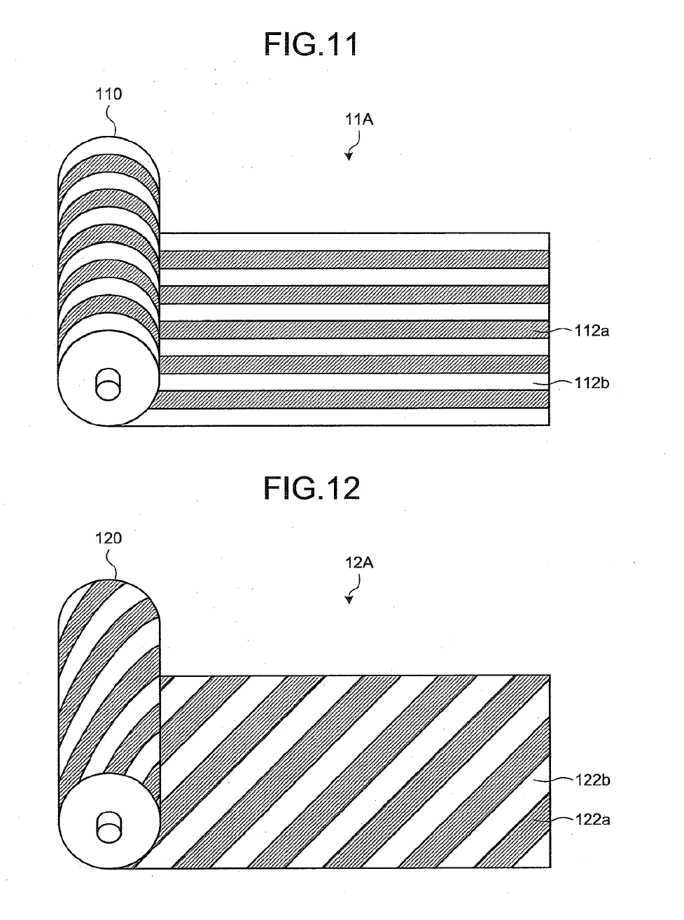

FIG. 11 is a view schematically showing a second phase difference film having a lengthy shape that can be manufactured by this method.

In FIG. 11, the second phase difference film 11A includes liquid crystal oriented resin regions 112a and isotropic resin regions 112b which extend in parallel in the lengthwise direction. The second phase difference film formed as a lengthy-shaped film may be stored in a form of a roll 110.

Both when using a fixed type photomask and when using a conveyance type photomask, the regions patterned in stripes parallel to the lengthwise direction of the film shown in FIG. 11 may be formed by providing light shielding portions in stripes parallel to the lengthwise direction and performing UV exposure therethrough. Specifically, the liquid crystal layer forming composition is applied onto the substrate that has been subjected to a rubbing treatment or a orientation treatment with polarized UV. The resultant is heated to remove the organic solvent and to cause orientation of the liquid crystal compound. Then UV exposure is performed on the oriented layer by using the aforementioned photomask, to form cured resin layer regions and uncured resin layer regions in a form of stripes.

The condition for heating the liquid crystal layer forming composition for orientation is usually 40° C. or higher and preferably 50° C. or higher, and usually 200° C. or lower and preferably 140° C. or lower. The processing time of the heating treatment is usually not less than 1 second and preferably not less than 5 seconds, and usually not more than 3 minutes and preferably not more than 120 seconds. The light irradiation may be performed, e.g., for 0.01 second to 3 minutes by using light having a wavelength of 200 to 500 nm. For example, desired regions of the layer of the oriented liquid crystal layer forming composition are irradiated with weak ultraviolet rays of 0.01 to 50 mJ/cm² in an inert gas such as nitrogen and argon or in the air, whereby resin layer regions having a phase difference of λ/2 are fixed. Then, uncured resin layer regions are heated to the higher temperature than the clearing point (NI point) of the liquid crystal compound, whereby the uncured resin layer regions are in an isotropic phase. Keeping that state, the layer is irradiated with relatively strong ultraviolet lays of, e.g., 50 to 10,000 mJ/cm² in an inert gas such as nitrogen and argon or in the air, whereby a resin layer including anisotropic regions having a phase difference of λ/2 and isotropic regions in the same layer can be obtained. When performing the UV exposure with a photomask, the UV irradiation may be performed through the photomask onto the side of the layer of liquid crystal layer forming composition on the substrate. The UV irradiation may also be performed onto the backside. Re of the second phase difference film may be measured by, e.g., a two-dimensional birefringence evaluation system “WPA-micro from Photonic Lattice, Inc.”.

The extending direction of the stripe-patterned regions is not limited to the lengthwise direction of the film, but may also be a direction diagonal to or orthogonal to the lengthwise direction of the film.

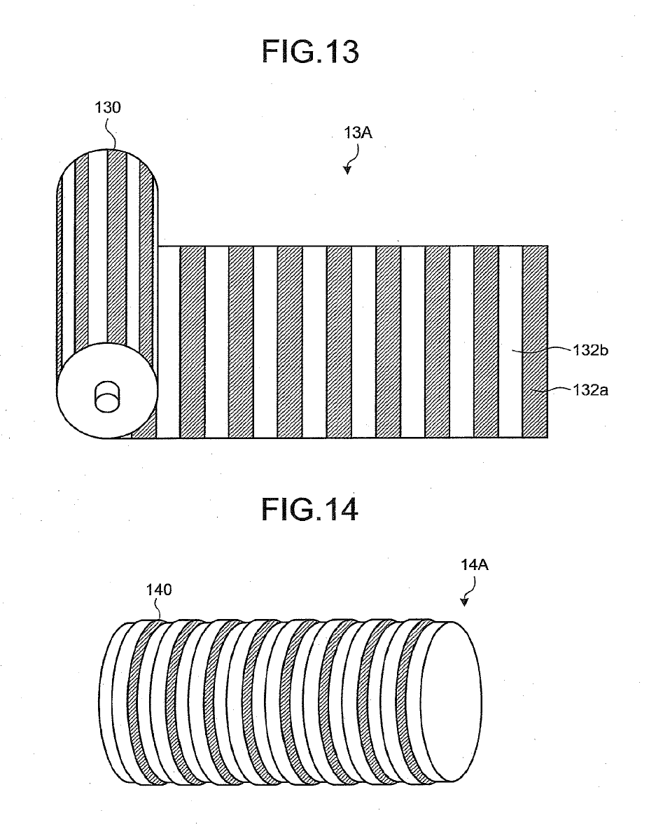

FIGS. 12 and 13 are views schematically showing other examples of the second phase difference film having a lengthy shape that can be manufactured by this method.

In FIG. 12, the second phase difference film 12A includes liquid crystal oriented resin regions 122a and isotropic resin regions 122b which extend in a direction diagonal to the lengthwise direction. The second phase difference film formed as a lengthy-shaped film may be stored in a form of a roll 120. In FIG. 13, the second phase difference film 13A includes liquid crystal oriented resin regions 132a and isotropic resin regions 132b which extend in a direction orthogonal to the lengthwise direction. The second phase difference film formed as a lengthy-shaped film may be stored in a form of a roll 130.

When using a fixed type photomask, the pattern of the stripes diagonal to the lengthwise direction of the film shown in FIG. 12 or the pattern orthogonal to the lengthwise direction of the film shown in FIG. 13 may be formed by providing light shielding portions of diagonal or orthogonal stripes and performing flash exposure therethrough in conformity with the conveyance speed. When using a conveyance type photomask, the pattern may be formed by providing light shielding portions of diagonal or orthogonal stripes and performing UV exposure therethrough. A suitable example of an application machine having such a mechanism is disclosed in WO 2008/007782.

(ii) Another method uses heat embossing. As shown in FIG. 14, recesses and projections 140 of a desired stripe pattern are formed on a roll 14A. When the roll is heated and brought in proximity to a film, only the projected portions of the recesses and projections 140 are brought in contact with the film, whereby those portions alone can be heated. As a result, the liquid crystal compound in the liquid crystal layer forming composition of the stripe pattern at the projected portions forms an isotropic phase, while the liquid crystal compound at the recessed portions maintains the orientation order. The film in such a state may be cured and fixed by UV exposure or other techniques, whereby a plurality of regions that are patterned in stripes can be formed on the liquid crystal layer. The direction of the stripes can be appropriately selected by means of the direction of the stripes of the recesses and projections formed on the roll.

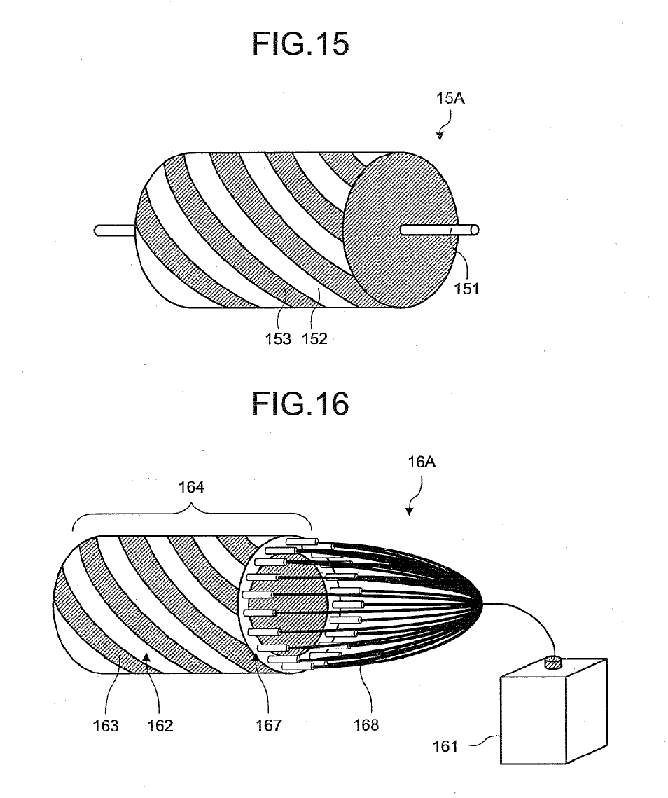

(iii) In the aforementioned method (i), selective exposure using a light-emitting roll may be performed instead of the selective exposure using a photomask. As used herein, a light-emitting roll refers to one having a structure that can emit UV light from the roll surface. For example, like a roll 15A shown in FIG. 15, a light-emitting roll may be configured by arranging a UV light source 151 inside a roll that has a high light shielding ability, and providing openings 152 for UV light output and light shielding portions 153 on the roll surface. By arranging the holes for UV light output so as to correspond to the desired stripe pattern, it is possible to create UV exposed regions and unexposed regions on the layer of the liquid crystal layer forming composition that passes over the roll, to thereby give a stripe pattern.

(iv) As another specific example of the light-emitting roll, a light guiding member 164 may be provided on the roll surface as a roll 16A shown in FIG. 16. UV light is introduced from an end surface 167 of the light guiding member, and the UV light is taken out from the light output portions of light guiding portions 162. In this case, by providing light shielding portions 163 corresponding to the desired stripe pattern on the light output portions of the light guide member 164, it is possible to create UV exposed regions and unexposed regions on the layer of the liquid crystal layer forming composition that passes over the roll, to give a stripe pattern. The UV light may be supplied from a UV light source 161 to the end surface 167 through optical fibers 168.

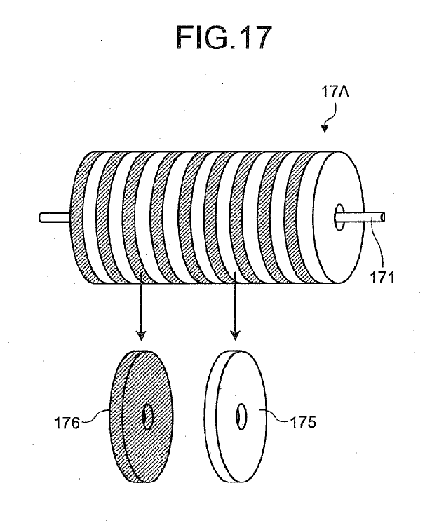

(v) As another specific example of the light-emitting roll, a UV light source 171 may be installed inside a roll shaft as a roll 17A shown in FIG. 17. By arranging light guiding disks 175 and light shielding disks 176 in a row, it is possible to create UV exposed regions and unexposed regions on the liquid crystal layer that passes over the roll, to give a stripe pattern.

By performing the aforementioned selective exposure or selective heating, it is possible to obtain region-specific different phase differences even if the applied liquid crystal layer forming composition and the surface on which the liquid crystal layer forming composition is applied have no region-specific differences. Consequently, the plurality of regions can be efficiently formed without performing difficult operations such as region-specific different orientation treatments (e.g., rubbing treatment) and the application of different liquid crystal layer forming compositions for respective regions, but with a uniform orientation treatment performed on the entire surface for applying the liquid crystal layer forming composition and with the state wherein the same liquid crystal layer forming composition is applied onto the entire surface.

<Phase Difference Film Stacked Body Having a Lengthy Shape>

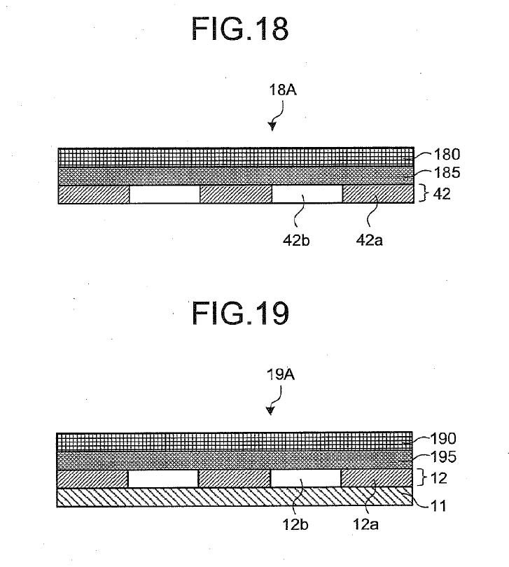

The phase difference film stacked body according to the present invention includes the first phase difference film and the second phase difference film. FIGS. 18, 19, 20, 21, and 22 show examples of the phase difference film stacked body according to the present invention.

FIG. 18 is a cross-sectional view showing an example of a phase difference film stacked body formed by pasting the second phase difference film shown in FIG. 4 to a first phase difference film via a sticky layer. More specifically, the phase difference film stacked body 18A shown in FIG. 18 includes a second phase difference film that consists only of the resin layer 42 including the liquid crystal oriented resin regions 42a and the isotropic resin regions 42b. The phase difference film stacked body 18A further includes a first phase difference film 180 which is pasted to the resin layer 42 via a sticky layer or adhesive layer 185.

FIG. 19 is a cross-sectional view showing an example of a phase difference film stacked body formed by pasting the second phase difference film shown in FIG. 1 to a first phase difference film via a sticky layer. More specifically, the phase difference film stacked body 19A shown in FIG. 19 includes a second phase difference film that includes the resin layer 12 including the liquid crystal oriented resin regions 12a and the isotropic resin regions 12b and the substrate 11. The phase difference film stacked body 19A further includes a first phase difference film 190 which is pasted to the resin layer 12 via a sticky layer or adhesive layer 195.

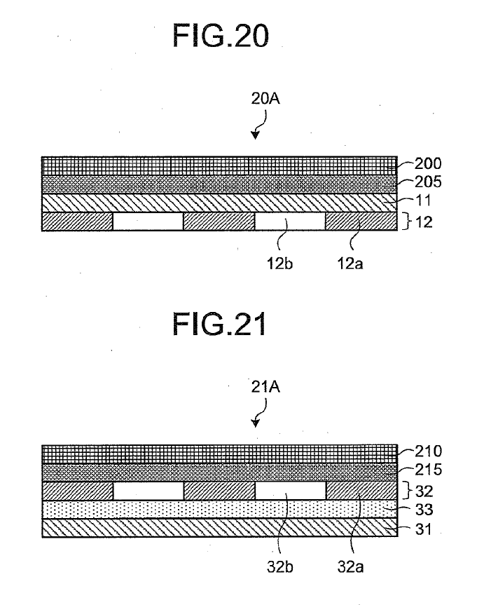

Like FIG. 19, FIG. 20 is a cross-sectional view showing an example of a phase difference film stacked body formed by pasting the second phase difference film shown in FIG. 1 to a first phase difference film via an adhesive layer or sticky layer. This example differs from the example of FIG. 19 in that the substrate side of the second phase difference film is pasted to the first phase difference film. More specifically, the phase difference film stacked body 20A shown in FIG. 20 includes a second phase difference film that includes the resin layer 12 including the liquid crystal oriented resin regions 12 and the isotropic resin regions 12b and the substrate 11. The phase difference film stacked body 20A further includes a first phase difference film 200 which is pasted to the substrate 11 via a sticky layer or adhesive layer 205.

FIG. 21 is a cross-sectional view showing an example of a phase difference film stacked body formed by pasting the second phase difference film shown in FIG. 3 to a first phase difference film via a sticky layer. More specifically, the phase difference film stacked body 21A shown in FIG. 21 includes a second phase difference film that includes the substrate 31 and the resin layer 32 including the liquid crystal oriented resin regions 32a and the isotropic resin regions 32b, pasted to the substrate 31 via a sticky layer or adhesive layer 33. The phase difference film stacked body 21A further includes a first phase difference film 210 which is pasted to the resin layer 32 via a sticky layer or adhesive layer 215.

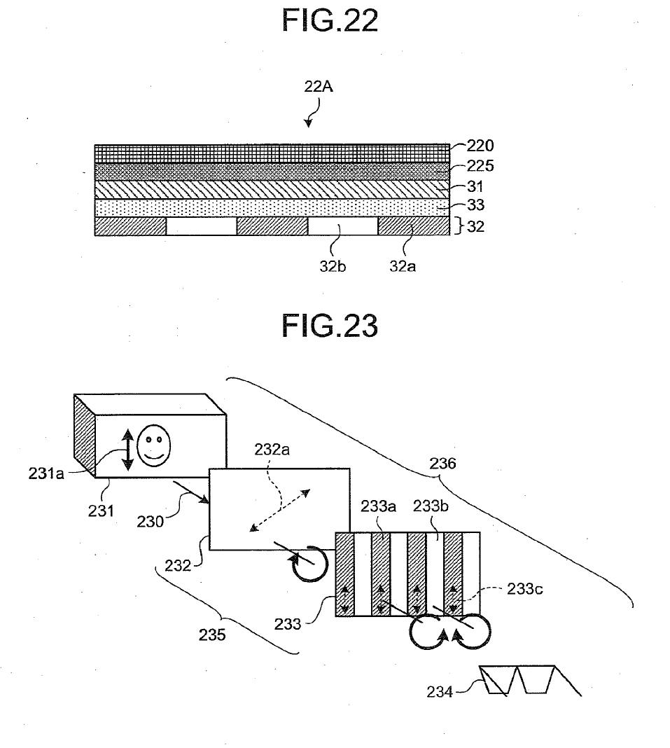

FIG. 22 is a cross-sectional view showing another example of the phase difference film stacked body formed by pasting the second phase difference film shown in FIG. 3 to a first phase difference film via a sticky layer. More specifically, the phase difference film stacked body 22A shown in FIG. 22 includes a second phase difference film that includes the substrate 31 and the resin layer 32 including the liquid crystal oriented resin regions 32a and the isotropic resin regions 32b, pasted to the substrate 31 via a sticky layer or adhesive layer 33. The phase difference film stacked body 22A further includes a first phase difference film 220 which is pasted to the substrate 31 via a sticky layer or adhesive layer 225.

Examples of the adhesive agents and sticky agents used in the adhesive layers and sticky layers may include adhesive agents that lose stickiness at normal temperatures when cured (including hot-melt adhesive agents, UV curable sticky agents, and EB curable sticky agents) and sticky agents that will not lose stickiness (such as pressure sensitive adhesive agents). Although there is no particular limitation to the selection of the adhesive agent, a highly transparent adhesive agent is usually used. In order to shorten the time of the manufacturing processes, a sticky agent that does not change in physical property immediately after pasting and an adhesive agent that cures quickly (such as hot-melt adhesive agents, UV curable adhesive agents, and EB curable adhesive agents) are preferred. For securing reliability and mechanical strength of the product, a UV curable adhesive agent and an EB curable adhesive agent are particularly preferred. As the adhesive agent, one species thereof may be used alone, or two or more thereof may be used in combination in arbitrary proportions.

The phase difference film stacked body according to the present invention may be continuously formed as a lengthy-shaped stacked body by combining the aforementioned first and second phase difference films. Specifically, the phase difference film stacked body of the present invention may be formed by continuously pasting the first phase difference film and the second phase difference film in a roll-to-roll manner. As, used herein, a film having a “lengthy shape” refers to a film having a length at least five times or more the width, preferably refers to a film having a length at least 10 times or more the width, and specifically refers to a film having a length such that it is wound to be in a form roll for storage or transportation.

In the present application, a “stacked body” refers to a structure including a plurality of layers. A “film stacked body” refers to a film including a plurality of layers. The term “stacked body” does not particularly limit the method for forming the plurality of layers constituting the same. For example, a stacked body including two layers may be manufactured by forming one of the layers and then forming the other layer on a surface thereof. Alternatively, two layers may be separately formed and then pasted.

<Display Device of the Present Invention>

The display device according to the present invention is a display device having a display region for the right eye and a display region for the left eye, and includes a cut article of the aforementioned phase difference film stacked body according to the present invention. In the display device according to the present invention, the phase difference film stacked body is arranged so that the first region and the second region of the phase difference film stacked body correspond to the display region for the right eye and the display region for the left eye, respectively. The cut article may be obtained by appropriately cutting the lengthy-shaped phase difference film stacked body to a size conforming to the display device.

An embodiment of the present invention may be an embodiment wherein a display unit 231 and a phase difference film stacked body 235 are arranged as shown in FIG. 23. In FIG. 23, 223 denotes a first phase difference film, 232a denotes the slow axis of the first phase difference film, 233 denotes a second phase difference film, 233a denotes first regions, and 233b denotes second regions. The reference numeral 233c indicates the direction of the slow axes in the first regions. The second regions 233b are isotropic regions. A combination of these elements and polarization glasses 234 constitutes a three-dimensional image device 236.

In the configuration with the arrangement as in FIG. 23 the polarization axis 231a of the polarized light emitted from the display unit (i.e., the direction corresponding to the transmission axis of the polarizing plate) is parallel to the vertical direction of the display unit), the slow axis 232a of the first phase difference film has to have a slow axis in a direction that is not parallel to the polarization axis 231a of the polarized light emitted from the display unit. If the first phase difference film had a slow axis substantially parallel to the polarization axis 231a, the incident light 230 would pass therethrough without any birefringent effect. In order to convert the incident light 230 into circular polarization or approximately circular polarization at the next second phase difference film, the slow axes of the second phase difference film in the respective regions would have to intersect the lengthwise direction in different directions. This would sacrifice efficiency and productivity, failing to achieve the object of the present invention. For ordinary liquid crystal TVs and the like that emit polarized light in a polarized state as shown in FIG. 23, the first phase difference film preferably has a slow axis in the range of 35° to 55°, and more preferably in the range of 40° to 50°, with respect to the lengthwise direction.

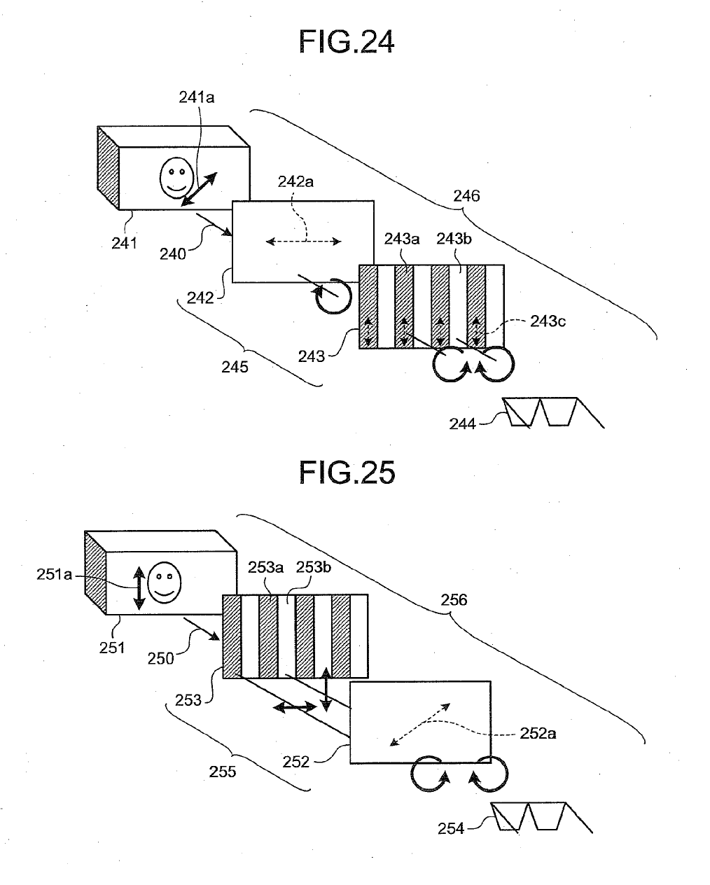

FIG. 24 shows an example of a combination with a different type of display unit. In the example shown in FIG. 24, a display unit 241 and a phase difference film stacked body 245 are combined to constitute a display device. In FIG. 24, 242 denotes a first phase difference film, 242a denotes the slow axis of the first phase difference film, 243 denotes a second phase difference film, 243a denotes first regions, and 243b denotes second regions. The reference numeral 243c indicates the direction of the slow axes in the first regions. The second regions 243b are isotropic regions. A combination of these elements and polarization glasses 244 constitutes a three-dimensional image device 246. The reference numeral 241a denotes the polarization axis of the light emitted from the display unit. Unlike the display unit 231 of FIG. 23, the display unit 241 has a polarization axis in a direction diagonal to the vertical direction of the display unit. In such a case, the slow axis 242a of the first phase difference film has to be arranged in a direction that is not parallel to the polarization axis 241a of the light 240 emitted from the display unit. Usually, when the first phase difference film is made of a stretched polymer or a liquid crystal resin layer, the slow axis thereof may be arranged to be approximately orthogonal to the lengthwise direction because the product is required to have a width as large as possible. In this case, the crossing angle is preferably in the range of 35° to 55°, and more preferably in the range of 40° to 50°.

In the embodiments shown in FIGS. 23 and 24, the second phase difference film is arranged on the uppermost surface of the display device that is the closest to the observer. In these embodiments, if necessary, it is possible to provide a hardcoat layer and/or an antireflection film directly on the uppermost surface of the second phase difference film. It is also possible to paste a film including a hardcoat layer and/or an antireflection layer formed on an appropriate substrate, and the film may be pasted via a sticky layer or adhesive layer. As the material for the hardcoat layer, those disclosed in WO 2006/019086 may be appropriately used. The hardcoat layer is a layer having a function of improving the surface hardness of the substrate, and preferably shows a hardness of “H” or higher in a pencil hardness test described in JIS K5600-5-4 (a glass plate is used as a test plate). Preferred materials for forming the hardcoat layer (hardcoat materials) are those that cure by heat or light. Examples thereof may include organic hardcoat materials such as organic silicone-based, melamine-based, epoxy-based, acrylic-based, and urethane acrylate-based; and inorganic hardcoat materials such as silicon dioxide. As the material for the antireflection layer, those disclosed in WO 2005/001525 may be appropriately used. The antireflection layer is a layer for preventing reflection of external light, and is deposited directly on the surface of a substrate or via another layer such as a hardcoat layer. It is preferable that the substrate on which the antireflection layer is formed has a reflectance of 2.0% or less at an incident angle of 5° and wavelengths of 430 nm to 700 nm (measured by, e.g., a UV/VIS/NIR spectrophotometer V-570 from JASCO Corporation), and preferably 1.0% or less at an incident angle of 5° and a wavelength of 550 nm. Low-birefringent substrates are the best suited for such applications. Examples of usable substrates may include acetate-based polymer resins such as triacetylcellulose (for example, TAC films from Konica Minolta), and alicyclic olefin-based polymer resins (for example, ZEONOR Film (registered trademark) from ZEON Corporation). The hardcoat layer and the antireflection layer may also be formed by firstly forming these layers or a birefringent substrate and then transferring these layers to the second phase difference film via a sticky layer or adhesive layer. In this case, as the materials for the hardcoat layer, the antireflection layer, and the sticky or adhesive layer, those mentioned above may be appropriately used. In order to perform positioning of the display device and the phase difference film stacked body upon arranging these members, it is preferable to provide reference marks for positioning so that the pixel positions of the display panel and the pattern position of the second phase difference film come into a desired positional relationship. Another member provided with reference marks may be used as an auxiliary member.

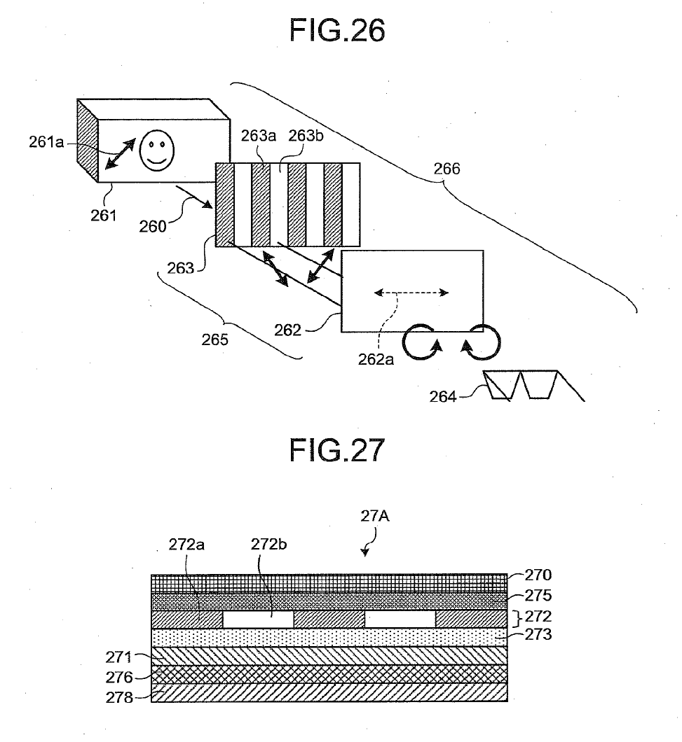

FIGS. 25 and 26 show embodiments of the present invention that are different from aforementioned ones.

In the example shown in FIG. 25, a display unit 251 and a phase difference film stacked body 255 are combined to constitute a display device. In FIG. 25, 252 denotes a first phase difference film, 252a denotes the slow axis of the first phase difference film, and 253 denotes a second phase difference film. A combination of these elements and polarization glasses 254 constitutes a three-dimensional image device 256. The reference numeral 251a denotes the polarization axis of light 250 emitted from the display unit. The reference numeral 253a denotes twisted nematic (TN) regions which rotate the linearly polarized light 250 incident on the regions by 90°, and 253b denotes isotropic regions which are cured while the liquid crystal molecules are in a randomly oriented state.

In the example shown in FIG. 26, a display unit 261 and a phase difference film stacked body 265 are combined to constitute a display device. In FIG. 26, 262 denotes a first phase difference film, 262a denotes the slow axis of the first phase difference film, and 263 denotes a second phase difference film. A combination of these elements and polarization glasses 264 constitutes a three-dimensional image device 266. The reference numeral 261a denotes the polarization axis of light 260 emitted from the display unit. The reference numeral 263a denotes twisted nematic (TN) regions which rotate the linearly polarized light 260 incident on the regions by 90°, and 263b denotes isotropic regions which are cured whiled the liquid crystal molecules are in a randomly oriented state.

In the cases of FIGS. 25 and 26, the first phase difference film is arranged at the uppermost surface that is the closest to the observer. Also in these cases, the hardcoat layer, the antireflection layer, and the sticky or adhesive layer may be combined as described above. In a more preferable embodiment, an ultraviolet absorber may be introduced into the first phase difference film. As the first phase difference film having such a feature, it is preferable to use a multilayer extruded film formed by simultaneously extruding and then stretching a plurality of layers containing a resin having high solubility to the ultraviolet absorber. Suitable examples of the multilayer extruded film may include multilayer films that are disclosed in Japanese Patent No 4461795 B and Japanese Patent Application Laid-Open Nos. 2006-212988 A, 2006-212989 A, 2008-73890 A, and 2009-178899 A by using multilayer extruders disclosed in Japanese Patent Application Laid-Open Nos. 2006-188018 A and 2006-231763 A. The phase difference film stacked body thus formed is pasted onto a dichroic polarizer (not shown) on the display device via a sticky layer or adhesive layer. If the polarizing plate has protection layers on both sides, either one of the protection layers may be omitted. In this case, a sticky layer or adhesive layer is used between the polarizer and the phase difference film stacked body. Examples of the sticky layer or adhesive layer for such a purpose may include acrylic-based, urethane-based, polyester-based, polyamide, polyvinyl ether, polyvinyl alcohol, polyvinyl acetal, polyvinyl formal, hydroxyethyl cellulose, hydroxypropyl cellulose, ethylene-vinyl acetate-based, ethylene-acrylate ester-based, ethylene-vinyl chloride-based, synthetic rubber-based such as styrene-butadiene-styrene, epoxy-based, and silicone-based polymers. If a wapage or the like of the polarizing plate may cause problem, a nonaqueous ultraviolet curable adhesive layer of, e.g., epoxy-based, urethane-based, or polyester-based is preferably used.

<Polarizing Plate Complex>

The polarizing plate complex according to the present invention includes the phase difference film stacked body according to the present invention and a polarizing plate. FIGS. 27 to 31 show examples of the polarizing plate complex according to the present invention (polarizing plate protective layers are not shown). When a lengthy-shaped polarizing plate is continuously pasted to a lengthy-shaped phase difference film stacked body according to the present invention, the transmission axis of the polarizing plate and the pattern direction of the second phase difference film may have to intersect each other. The second phase difference film having a pattern direction diagonal to the lengthwise direction may be created as previously described.

In FIG. 27, the polarizing plate complex 27A includes a phase difference film stacked body including: a substrate 271; an orientation film 273 which is formed on the substrate 271; a resin layer 272 which is formed on the orientation film 273 and includes liquid crystal oriented resin regions 272a and isotropic resin regions 272b; and a first phase difference film 270 which is provided on the resin layer 272 via a sticky layer or adhesive layer 275. The polarizing plate complex 27A also includes a polarizing plate 278 which is provided on the substrate 271 via a sticky layer or adhesive layer 276.

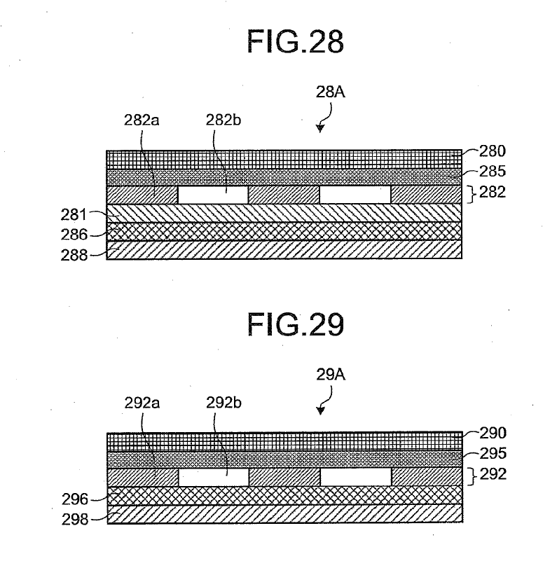

In FIG. 28, the polarizing plate complex 28A includes a phase difference film stacked body including: a substrate 281; a resin layer 282 which is formed on the substrate 281 without an orientation film interposed therebetween and includes liquid crystal oriented resin regions 282a and isotropic resin regions 282b; and a first phase difference film 280 which is provided on the resin layer 282 via a sticky layer or adhesive layer 285. The polarizing plate complex 28A also includes a polarizing plate 288 which is provided on the substrate 281 via a sticky layer or adhesive layer 286.

In FIG. 29, the polarizing plate complex 29A includes a phase difference film stacked body including: a resin layer 292 which includes liquid crystal oriented resin regions 292a and isotropic resin regions 292b; and a first phase difference film 290 which is provided on the resin layer 292 via a sticky layer or adhesive layer 295. The polarizing plate complex 29A also includes a polarizing plate 298 which is provided on the resin layer 292 via a sticky layer or adhesive layer 296.

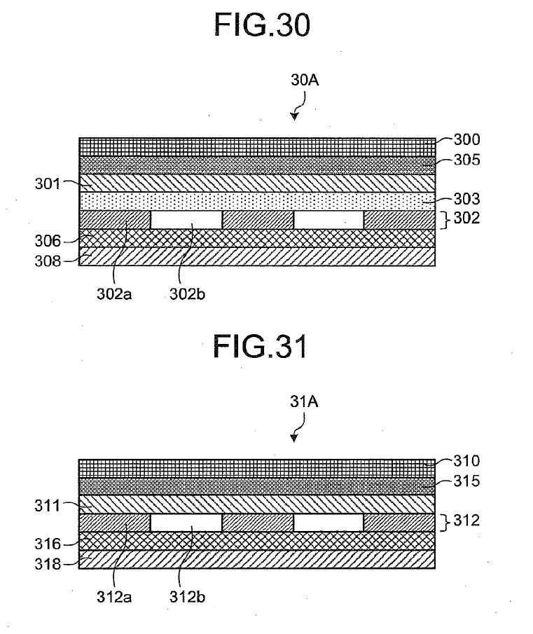

In FIG. 30, the polarizing plate complex 30A includes a phase difference film stacked body including: a substrate 301; an orientation film 303 which is formed on the substrate 301; a resin layer 302 which is formed on the orientation film 303 and includes liquid crystal oriented resin regions 302a and isotropic resin regions 302b; and a first phase difference film 300 which is provided on the substrate 301 via a sticky layer or adhesive layer 305. The polarizing plate complex 30A also includes a polarizing plate 308 which is provided on the resin layer 302 via a sticky layer or adhesive layer 306.

In FIG. 31, the polarizing plate complex 31A includes a phase difference film stacked body including: a substrate 311; a resin layer 312 which is formed on the substrate 311 without an orientation film interposed therebetween and includes liquid crystal oriented resin regions 312a and isotropic resin regions 312b; and a first phase difference film 310 which is provided on the substrate 311 via a sticky layer or adhesive layer 315. The polarizing plate complex 31A also includes a polarizing plate 318 which is provided on the resin layer 312 via a sticky layer or adhesive layer 316.

<Relationship Between Phase Difference Film Stacked Body and Polarization Glasses>

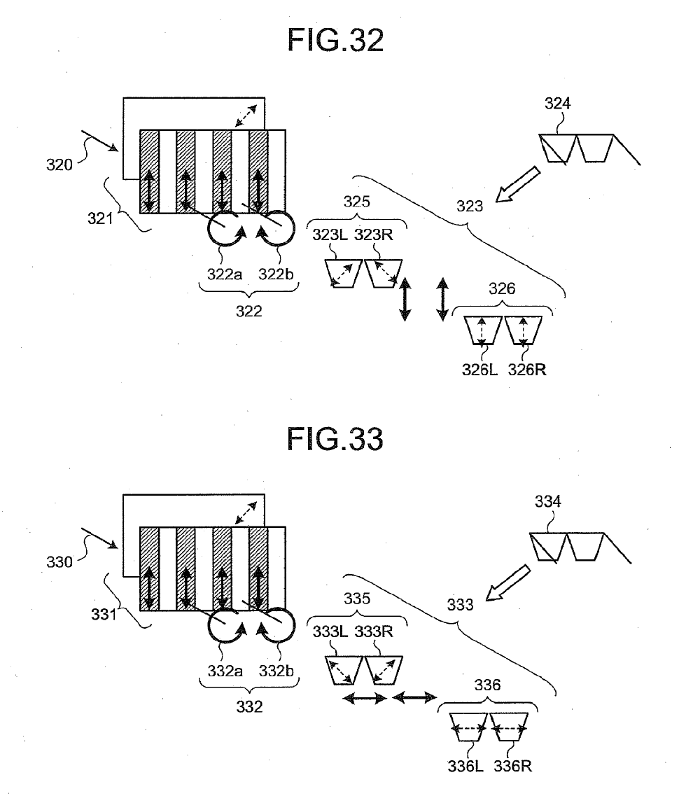

In order to visually observe a three-dimensional image by using an ordinary display device of a passive type, right and left circular polarization glasses having transparency only to circularly polarized light in respective different rotational directions are required. FIGS. 32 and 33 show mechanisms for visually observing a three-dimensional image. In FIGS. 32, 325 and 326 show an example of a combination 323 of members constituting circular polarization glasses 324. In FIGS. 33, 335 and 336 show an example of a combination 333 of members constituting circular polarization glasses 334.

An image for the right eye and an image for the left eye, displayed on a display unit (not shown) and incident as shown by the arrows 320 and 330, are converted into right and left circularly polarized images 322 and 332 through phase difference film stacked bodies 321 and 331 of the present invention, respectively. The reference numerals 323L, 323R, 333L, and 333R denote λ/4 plates, and 326 and 336 denote polarizing plates.

In the embodiment of FIG. 32, one of the right and left circularly polarized images 322 that has passed through the liquid crystal oriented resin regions of the second phase difference film is used as an image for the left eye, and one that has passed through the isotropic resin regions is used as an image for the right eye. The image for the left eye is emitted from the phase difference film stacked body 321 as left circularly polarized light 322a. The image for the right eye is emitted from the phase difference film stacked body 321 as right circularly polarized light 322b.

The image of the left circularly polarized light 322a is converted into linearly polarized light parallel to the transmission axes of the polarizing plates 326 by one λ/4 plate 323L of the polarization glasses, and converted into linearly polarized light orthogonal to the transmission axes of the polarizing plates 326 by the other λ/4 plate 323R of the polarization glasses. The light thus passes through the polarizing plate 326L for the left eye and is shielded by the polarizing plate 326R for the right eye, and reaches one of the eyes of the observer. On the other hand, the image of the right circularly polarized light 322b is converted into linearly polarized light parallel to the transmission axes of the polarizing plates 326 by one λ/4 plate 323R of the polarization glasses, and converted into linearly polarized light orthogonal to the transmission axes of the polarizing plates 326 by the other λ/4 plate 323L of the polarization glasses. The light thus passes through the polarizing plate 326L for the right eye and is shielded by the polarizing plate 326R for the left eye, and reaches the other eye of the observer. This produces a parallax between the displayed images, and the observer recognizes this in a three-dimensional manner.

In the embodiment of FIG. 33, in the same manner as in FIG. 32, the image that has passed through the liquid crystal oriented resin regions of the second phase difference film is used as an image for the left eye, and the image that has passed through the isotropic resin regions is used as an image for the right eye. The image for the left eye is emitted from the phase difference film stacked body 331 as left circularly polarized light 332a. The image for the right eye is emitted from the phase difference film stacked body 331 as right circularly polarized light 332b.

The image of the left circularly polarized light 332a is converted into linearly polarized light parallel to the transmission axes of the polarizing plates 336 by one λ/4 plate 333L of the polarization glasses, and converted into linearly polarized light orthogonal to the transmission axes of the polarizing plates 336 by the other λ/4 plate 333R of the polarization glasses. The light thus passes through the polarizing plate 336L for the left eye and is shielded by the polarizing plate 336R for the right eye, and reaches one of the eyes of the observer. On the other hand, the image of the right circularly polarized light 332b is converted into linearly polarized light parallel to the transmission axes of the polarizing plates 336 by one λ/4 plate 333R of the polarization glasses, and converted into linearly polarized light orthogonal to the transmission axes of the polarizing plate 336 by the other λ/4 plate 333L of the polarization glasses. The light thus passes through the polarizing plate 336L for the right eye and is shielded by the polarizing plate 336R for the left eye, and reaches the other eye of the observer. This produces a parallax between the displayed images, and the observer recognizes this in a three-dimensional manner.

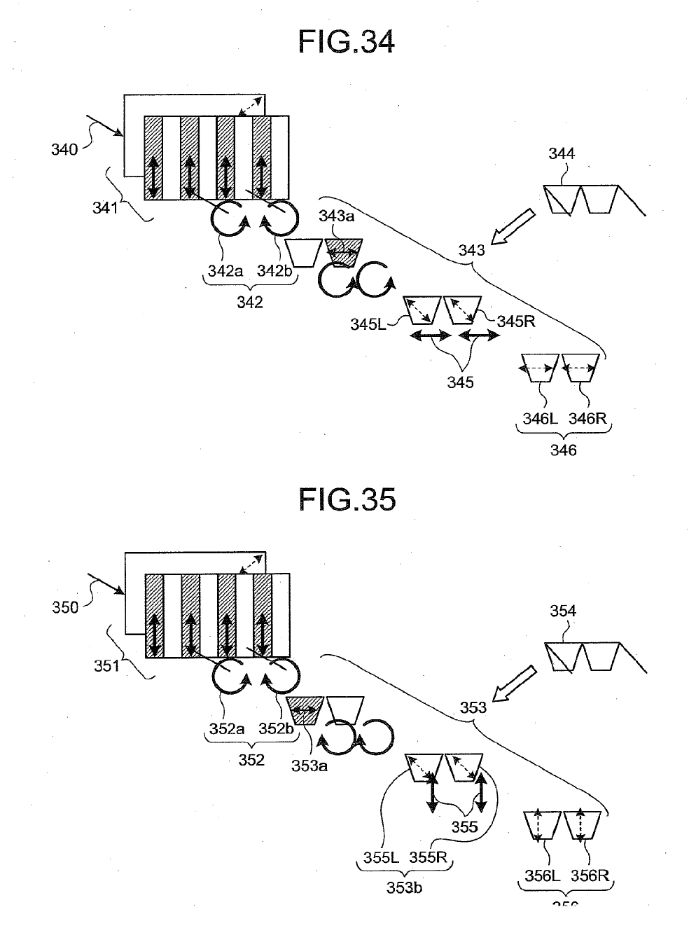

In an instance wherein the phase difference film stacked body and the polarization glasses of the present invention manufactured by the materials and method described in FIG. 33 are arranged in a manner as explained above, when the image 332b for the right eye is incident on the glass for the left eye, since the slow axis of the liquid crystal oriented resin regions of the second phase difference film of the phase difference film stacked body 331 is orthogonal to the slow axis of the λ/4 plate 333L of the polarization glass, wavelength dispersions cancel out each other to produce the same linear polarization state as that of the incident light. Ideally, the image for the right eye is thus blocked by the polarizing plate 336L for the left eye of the polarization glass and will not reach the observer. On the other hand, when the image 332a for the left eye that has passed through the liquid crystal oriented resin regions is incident on the glass for the right eye, the light shielding by the polarizing plate 336R for the right eye of the polarization glass may be incomplete, and light leakage can occur. Such leakage of light is attributable to the fact that, although the polarizing plate functions as a λ/2 plate to light of near 550 nm in wavelength (green region), the polarizing plate fails to function as an exact λ/2 plate to light of shorter wavelengths (blue region) and longer wavelengths (red region) due to the liquid crystal's wavelength dispersibility, failing to convert the polarization direction in a perfect linear polarization state to cause elliptical polarization. This may raise a problem of causing a phenomenon that the image for the left eye which should be hidden from the right eye becomes visible (crosstalk) which impedes three-dimensional image recognition. Such a problem can be solved by providing a compensation layer that cancels wavelength dispersion caused by the phase difference film used in the display device on the polarization glasses to be used, as shown in FIGS. 34 and 35. More specifically, a compensation layer 343a or 353a corresponding to the first regions and second regions of the second phase difference film may be provided between the display device and the λ/4 plate 343b or 353b. FIGS. 34 and 35 show such a state. Note that when seen from the observer's side, the slow axis of the second phase difference film on the display device side and the slow axis of the compensation layer 343a or 353a are in an orthogonal relationship.

In the example shown in FIG. 34, a display device including a phase difference film stacked body 341 and polarization glasses 344 are used in combination. The polarization glasses 334 include a combination 343 of members including the compensation layer 343a which is a λ/2 plate for the right eye alone, as well as λ/4 plates 343b and polarizing plates 346. In this example, among the images of linearly polarized light incident on the phase difference film stacked body 341 from the display unit along an arrow 340, the light of the image for the left eye passes through the λ/4 plate and the λ/2 plate and emitted from the display device as left circularly polarized light 342a. The left circularly polarized light passes through the λ/4 plate 345L in the combination 343 of members of the polarization glasses, and thereby converted into linearly polarized light 345 which passes through the polarizing plate 346L to reach the left eye. Meanwhile, among the images of the linearly polarized light incident on the phase difference film stacked body 341 from the display unit along the arrow 340, the light of the image for the right eye passes through the λ/4 plate and emitted from the display device as right circularly polarized light 342b. The right circularly polarized light passes through the λ/2 plate 343a and the λ/4 plate 345R in the combination 343 of members of the polarization glasses, and thereby converted into linearly polarized light 345 which passes through the polarizing plate 346R to reach the right eye.

In the example shown in FIG. 35, a display device including a phase difference film stacked body 351 and polarization glasses 354 are used in combination. The polarization glasses 354 include a combination 353 of members including the compensation layer 353a which is a λ/2 plate for the left eye alone, as well as λ/4 plates 353b and polarizing plates 356. In this example, among the images of the linearly polarized light incident on the phase difference film stacked body 351 from the display unit along an arrow 350, the light of the image for the left eye passes through the λ/4 plate and the λ/2 plate and emitted from the display device as left circularly polarized light 352a. The left circularly polarized light passes through the λ/2 plate 353a and the λ/4 plate 355L in the combination 353 of members of the polarization glasses, and thereby converted into linearly polarized light 355 which passes through the polarizing plate 356L to reach the left eye. Meanwhile, among the images of the linearly polarized light incident on the phase difference film stacked body 351 from the display unit along the arrow 350, the light of the image for the right eye passes through the λ/4 plate and emitted from the display device as right circularly polarized light 352b. The right circularly polarized light passes through the λ/4 plate 355R in the combination 353 of members of the polarization glasses, and thereby converted into linearly polarized light 355 which passes through the polarizing plate 356R to reach the right eye.

Since such an arrangement is employed, when the image for the right eye is incident on the glass for the left eye and the image for the left eye on the glass for right eye, the state of linear polarization becomes the same as that of the incident light (in an orthogonal relationship with the transmission axes of the polarizers of the polarization glasses). Ideally, the images are perfectly shielded by the polarizers of the polarization glasses, whereby the occurrence of crosstalk can be suppressed. The polarization glasses according to the present invention may appropriately be combined with the aforementioned layers such as the hardcoat layer, the antireflection layer, and the sticky or adhesive layer.

### EXAMPLES

The present invention will be specifically described hereinbelow with referring to Examples. However, the present invention is not limited to the following Examples, and may be practiced with arbitrary modifications without departing from the scope of claims of the present invention and equivalents thereof.

### Preparative Example 1

### Manufacture of Transparent Resin Substrate Having Orientation Film

Both sides of a film formed of an alicyclic olefin-based polymer (trade name “ZEONOR Film (registered trademark) ZF14-100” from OPTES Inc.) were subjected to corona discharge treatment so that the wetting index thereof was 56 dyne/cm, using a conveyor type corona discharge surface treatment from Kasuga Denki, Inc., under the conditions of an output of 0.12 kW, a line speed of 5 m/min, and a film/treatment electrode distance of 10 mm. A 5 wt % aqueous solution of polyvinyl alcohol was applied onto one side of the film using a #2 wire bar to form a coating layer. The coating layer was dried to form an orientation film having a thickness of 0.1 μm. Subsequently, rubbing treatment was applied onto the orientation film to manufacture a transparent resin substrate having an orientation film.

### Preparative Example 2

### Preparation of Liquid Crystal Layer Forming Composition 1

Components were mixed in the ratio (parts by weight) shown in Table 1 to prepare a liquid crystal layer forming composition. The components included in the liquid crystal layer forming composition are detailed below.

As the polymerizable liquid crystal compound, trade name LC242 (from BASF SE) was used. Δn value: 0.14 (Senarmont method).

As the polymerization initiator, trade name IRGACURE OXE02 (from Ciba Japan K.K.) was used.

As the surfactant, a fluorine surfactant (trade name FTERGENT 209F from NEOS COMPANY LTD.) was used.

### Preparative Example 3

### Preparation of Liquid Crystal Layer Forming Composition 2

Components were mixed in the ratio (parts by weight) shown in Table 1 to prepare a liquid crystal layer forming composition. An value: 0.14 (Senarmont method).

As the compound 1, the following compound was used. This compound 1 is a compound having no liquid crystallinity.

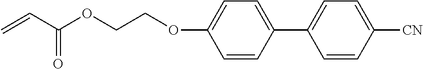 [SMILES: C=CC(=O)OCCOc1ccc(-c2ccc(C#N)cc2)cc1]

As the cross-linking agent, trimethylolpropane triacrylate was used.

### Preparative Example 4

### Preparation of Liquid Crystal Layer Forming Composition 3

Components were mixed in the ratio (parts by weight) shown in Table 1 to prepare a liquid crystal layer forming composition 3. An value: 0.14 (Senarmont method).

As the chiral agent, trade name LC756 (from BASF SE) was used.

TABLE 1

| | Liquid | Liquid | Liquid |
|---|---|---|---|
| | crystal layer | crystal layer | crystal layer |
| | forming | forming | forming |
| | composition 1 | composition 2 | composition 3 |
| Polymerizable | 40 | 30 | 39 |
| liquid crystal | | | |
| compound | | | |
| Compound 1 | — | 8 | — |
| Cross-linking | — | 2 | — |
| agent | | | |
| Chiral agent | — | — | 0.012 |
| Polymerization | 2 | 2 | 2 |
| initiator | | | |
| Surfactant | 0.04 | 0.04 | 0.04 |
| Cyclopentanone | 60 | 60 | 60 |

### Preparative Example 5

### Preparation of Second Phase Difference Film 1

At a temperature of 23° C., the liquid crystal layer forming composition 1 prepared in the Preparative Example 2 was applied onto a surface of the transparent resin substrate having an orientation film prepared in the Preparative Example 1 using a 44 wire bar. The application was performed on the surface having the orientation film. As a result, a coating layer of the liquid crystal layer forming composition was formed.

The coating layer was subjected to orientation treatment at 75° C. for two minutes. As a first ultraviolet irradiation, the layer was then irradiated with weak ultraviolet rays. In the first ultraviolet irradiation process, irradiation was performed with ultraviolet ray from a light source through a photomask having light shielding portions that was made with a resist, onto the backside (i.e., a side opposite to the side on which the coating layer was formed) of the transparent resin substrate. The amount of the ultraviolet ray was 0.1 to 45 mJ/cm². By this irradiation, liquid crystal oriented resin regions having a phase difference of λ/2 were formed.

Subsequently, by heating treatment of 130° C. for ten seconds, the coating layer other than the liquid crystal oriented resin regions was transformed from a liquid crystal phase into an isotropic phase. Keeping this state, a second ultraviolet irradiation was performed. In the second ultraviolet irradiation process, irradiation was performed with ultraviolet ray from a light source without a photomask interposed therebetween, onto the coating layer side (i.e., the side opposite to the aforementioned “backside”). The amount of the ultraviolet ray was 2000 mJ/cm². This irradiation was performed in a nitrogen atmosphere. By this irradiation, the coating layer was cured to thereby obtain a second phase difference film 1 including liquid crystal oriented resin regions having a phase difference of λ/2 and isotropic resin regions within the same resin layer. The dry thickness of the resin layer was 2 μm. The liquid crystal oriented resin regions had Re of 280 nm.

### Preparative Example 6

### Manufacture of Second Phase Difference Film 2

At a temperature of 23° C., the liquid crystal layer forming composition 2 prepared in the Preparative Example 3 was applied onto a surface of the transparent resin substrate having an orientation film prepared in the Preparative Example 1 using a #2 wire bar. The application was performed on the surface having the orientation film. As a result, a coating layer of the liquid crystal layer forming composition was formed.

The coating layer was subjected to orientation treatment at 65° C. for two minutes. As a first ultraviolet irradiation, the layer was then irradiated with weak ultraviolet rays. In the first ultraviolet irradiation process, irradiation was performed with ultraviolet ray from a light source through a photomask having light shielding portions that was made with a resist, onto the backside (i.e., a side opposite to the side on which the coating layer was formed) of the transparent resin substrate. The amount of the ultraviolet ray was 0.1 to 45 mJ/cm². By this irradiation, liquid crystal oriented resin regions having a phase difference of λ/2 were formed.

Subsequently, by heating treatment of 90° C. for ten seconds, the coating layer other than the liquid crystal oriented resin regions was transformed from a liquid crystal phase into an isotropic phase. Keeping this state, a second ultraviolet irradiation was performed. In the second ultraviolet irradiation process, irradiation was performed with ultraviolet ray from a light source without a photomask interposed therebetween, onto the coating layer side (i.e., the side opposite to the aforementioned “backside”). The amount of the ultraviolet ray was 2000 mJ/cm². This irradiation was performed in a nitrogen atmosphere. By this irradiation, the coating layer was cured to thereby obtain a second phase difference film 2 including liquid crystal oriented resin regions having a phase difference of λ/2 and isotropic resin regions within the same resin layer. The dry thickness of the resin layer was 1.5 μm. The liquid crystal oriented resin regions had Re of 270 nm.

### Preparative Example 7

### Manufacture of Second Phase Difference Film 3

At a temperature of 23° C., the liquid crystal layer forming composition 3 prepared in the Preparative Example 2 was applied onto a surface of the transparent resin substrate having an orientation film prepared in the Preparative Example 1 using a #36 wire bar. The application was performed on the surface having the orientation film. As a result, a coating layer of the liquid crystal layer forming composition was formed.

The coating layer was subjected to orientation treatment at 110° C. for two minutes. As a first ultraviolet irradiation, the layer was then irradiated with weak ultraviolet rays. In the first ultraviolet irradiation process, irradiation was performed with ultraviolet ray from a light source through a photomask having light shielding portions that was made with a resist, onto the backside (i.e., a side opposite to the side on which the coating layer was formed) of the transparent resin substrate. The amount of the ultraviolet ray was 0.1 to 45 mJ/cm². By this irradiation, resin regions with fixed nematic orientation were formed.

Subsequently, by heating treatment of 130° C. for ten seconds, the coating layer other than the resin regions with fixed nematic orientation was transformed from a liquid crystal phase into an isotropic phase. Keeping this state, a second ultraviolet irradiation was performed. In the second ultraviolet irradiation process, irradiation was performed with ultraviolet ray from a light source without a photomask interposed therebetween, onto the coating layer side (i.e., the side opposite to the aforementioned “backside”). The amount of the ultraviolet ray was 2000 mJ/cm². This irradiation was performed in a nitrogen atmosphere. By this irradiation, the coating layer was cured to thereby obtain a second phase difference film 3 having resin regions with fixed nematic orientation and isotropic resin regions within the same resin layer. The dry thickness of the resin layer was 20 μm.

The second phase difference film 3 was placed between two linear polarizing plates, and arranged so that the linear polarization transmission axes of the two linear polarizing plates matched with the rubbing direction of the second phase difference film 3. As a result, only the nematic resin layer portions were in a light extinction position. This means that the nematic resin layer of the second phase difference film 3 rotates the linearly polarized light by 90°. The nematic resin layer of the second phase difference film 3 was confirmed to form a nematic resin layer twisted by 90° about the thickness direction.

### Preparative Example 8

### Manufacture of λ/2 Film 1

A λ/2 film 1 was manufactured by the same method as the method for manufacturing the second phase difference film of the Preparative Example 5 except that the first ultraviolet irradiation was performed without a photomask (unlike the second phase difference film 1, the film consisted only of the anisotropic region). The resulting λ/2 film 1 had Re of 280 nm.

### Preparative Example 9

### Manufacture of λ/2 film 2

A λ/2 film 2 was manufactured by the same method as the method for manufacturing the second phase difference film of Preparative Example 6 except that the first ultraviolet irradiation was performed without a photomask (unlike the second phase difference film 2, the film consisted only of the anisotropic region). The resulting λ/2 film 2 had Re of 270 nm.

### Preparative Example 10

### Manufacture of Twisted Nematic Resin Film

A twisted nematic resin film was manufactured by the same method as the method for manufacturing the second phase difference film of the Preparative Example 7 except that the first ultraviolet irradiation was performed without a photomask (unlike the second phase difference film 3, the film consisted only of the anisotropic region).

### Preparative Example 11

### Manufacture of Circular Polarizing Plate 1

A pressure sensitive adhesive agent (referred to hereinbelow as PSA) was prepared by adding a curing agent E-AX (Soken Chemical & Engineering Co., Ltd.) to an acrylic sticky agent (SK-Dyne 2094 (from Soken Chemical & Engineering Co., Ltd., having a polymer containing ratio of 30% by weight)) in proportion of five parts by weight with respect to 100 parts by weight of the polymer in SR-Dyne 2094.

A first phase difference film (diagonally stretched ZEONOR Film (registered trademark) from ZEON Corporation) was pasted onto a polarizing plate (HLC2-5618 from Sanritz Corporation) using the PSA to obtain a circular polarizing plate 1 having the layer structure of (first phase difference film)/(PSA)/(polarizing plate).

In the circular polarizing plate 1, the direction of the slow axis of the first phase difference film and the direction of the transmission axis of the polarizing plate had a relationship as follows. When the observer observed from the polarizing plate-side surface, the direction of the slow axis of the first phase difference film was tilted by 45° counterclockwise with respect to the direction of the transmission axis of the polarizing plate.

### Preparative Example 12

### Manufacture of Circular Polarizing Plate 2

The phase difference λ/2 film 1 obtained in the Preparative Example 8 was pasted onto the surface of the circular polarizing plate 1 on the side of the first phase difference film using the PSA to obtain a circular polarizing plate 2 having the layer structure of (λ/2 film 1)/(PSA)/(first phase difference film)/(PSA)/(polarizing plate).

In the circular polarizing plate 2, the direction of the slow axis of the λ/2 film 1, the direction of the slow axis of the first phase difference film, and the direction of the transmission axis of the polarizing plate had a relationship as follows. When the observer observed from the polarizing plate-side surface, the direction of the slow axis of the λ/2 film 1 was orthogonal to the transmission axis of the polarizing plate. The direction of the slow axis of the first phase difference film was tilted by 45° counterclockwise with respect to the direction of the transmission axis of the polarizing plate.

### Preparative Example 13

### Manufacture of Circular Polarizing Plate 3

The phase difference λ/2 film 2 obtained in the Preparative Example 9 was pasted onto the surface of the circular polarizing plate 1 on the side of the first phase difference film using the PSA to obtain a circular polarizing plate 3 having the layer structure of (λ/2 film 2)/(PSA)/(first phase difference film)/(PSA)/(polarizing plate).

In the circular polarizing plate 3, the direction of the slow axis of the λ/2 film 2, the direction of the slow axis of the first phase difference film, and the direction of the transmission axis of the polarizing plate had a relationship as follows. When the observer observed from the polarizing plate-side surface, the direction of the slow axis of the λ/2 film 2 was orthogonal to the transmission axis of the polarizing plate. The direction of the slow axis of the first phase difference film was tilted by 45° counterclockwise with respect to the direction of the transmission axis of the polarizing plate.

### Preparative Example 14

### Manufacture of Circular Polarizing Plate 4

The twisted nematic resin film obtained in the Preparative Example 10 was pasted onto a polarizing plate (HLC2-5618 from Sanritz Corporation) using the PSA. A first phase difference film (diagonally stretched ZEONOR Film (registered trademark)) was further pasted onto the twisted nematic resin film using the PSA to obtain a circular polarizing plate 4 which included the first phase difference film/PSA/the twisted nematic resin film obtained in the Preparative Example 10/PSA/the polarizing plate stacked in this order.

In the circular polarizing plate 4, the direction of the slow axis of the first phase difference film and the direction of the transmission axis of the polarizing plate had a relationship as follows. When the observer observed from the polarizing plate-side surface, the direction of the slow axis of the first phase difference film was tilted by 45° counterclockwise with respect to the direction of the transmission axis of the polarizing plate.

### Preparative Example 15

### Manufacture of Polarization Glasses 1

The circular polarizing plate 1 and the circular polarizing plate 2 were placed in the view field of the left eye and the view field of the right eye of the observer, respectively, to obtain polarization glasses 1.

Both the circular polarizing plate 1 and the circular polarizing plate 2 were arranged so that their polarizing plate-side surfaces came to the observer side when the polarization glasses 1 were worn by the observer. Both the circular polarizing plate 1 and the circular polarizing plate 2 were also arranged so that the transmission axes of the polarizing plates were oriented in the vertical direction when worn by the observer. As a result, when the polarization glasses 1 were worn by the observer, the slow axis of the first phase difference film of the circular polarizing plate 1 was in the direction of upper left−lower right. The slow axis of the first phase difference film of the circular polarizing plate 2 was in the direction of upper left−lower right. The direction of the slow axis of the λ/2 film 1 was in the horizontal direction.

### Preparative Example 16

### Manufacture of Polarization Glasses 2

The circular polarizing plate 1 and the circular polarizing plate 3 were placed in the view field of the left eye and the view field of the right eye of the observer, respectively, to obtain polarization glasses 2.

Both the circular polarizing plate 1 and the circular polarizing plate 3 were arranged so that their polarizing plate-side surfaces came to the observer side when the polarization glasses 2 were worn by the observer. Both the circular polarizing plate 1 and the circular polarizing plate 3 were also arranged so that the transmission axes of the polarizing plates were oriented in the vertical direction when worn by the observer. As a result, when the polarization glasses 2 were worn by the observer, the slow axis of the first phase difference film of the circular polarizing plate 1 was in the direction of upper left−lower right. The slow axis of the first phase difference film of the circular polarizing plate 3 was in the direction of upper left−lower right. The direction of the slow axis of the λ/2 film 1 was in the horizontal direction.

### Preparative Example 17

### Manufacture of Polarization Glasses 3

The circular polarizing plate 1 and the circular polarizing plate 4 were placed in the view field of the left eye and the view field of the right eye of the observer, respectively, to obtain polarization glasses 3.

Both the circular polarizing plate 1 and the circular polarizing plate 4 were arranged so that their polarizing plate-side surfaces came to the observer side when the polarization glasses 3 were worn by the observer. Both the circular polarizing plate 1 and the circular polarizing plate 4 were also arranged so that the transmission axes of the polarizing plates were oriented in the vertical direction when worn by the observer. As a result, when the polarization glasses 3 were worn by the observer, the slow axis of the first phase difference film of the circular polarizing plate 1 was in the direction of upper left−lower right. The slow axis of the first phase difference film of the circular polarizing plate 4 was in the direction of upper left−lower right.

### Preparative Example 18

### Manufacture of Circular Polarizing Plate 5

A circular polarizing plate 5 was obtained by the same operation as in the Preparative Example 11 except that the angular relationship between the transmission axes and slow axes of the respective layers was changed as follows.

In the circular polarizing plate 5, the direction of the slow axis of the first phase difference film and the direction of the transmission axis of the polarizing plate had a relationship as follows. When the observer observed from the polarizing plate-side surface, the direction of the slow axis of the first phase difference film was tilted by 45° counterclockwise with respect to the direction of the transmission axis of the polarizing plate.

### Preparative Example 19

### Manufacture of Circular Polarizing Plate 6

A circular polarizing plate 6 was obtained by the same operation as in the Preparative Example 13 except that the angular relationship between the transmission axes and slow axes of the respective layers was changed as follows.

In the circular polarizing plate 6, the direction of the slow axis of the λ/2 film 2, the direction of the slow axis of the first phase difference film, and the direction of the transmission axis of the polarizing plate had a relationship as follows. When the observer observed from the polarizing plate-side surface, the direction of the slow axis of the λ/2 film 2 was parallel to the transmission axis of the polarizing plate. The direction of the slow axis of the first phase difference film was tilted by 45° counterclockwise with respect to the direction of the transmission axis of the polarizing plate.

### Preparative Example 20

### Manufacture of Polarization Glasses 4

The circular polarizing plate 5 and the circular polarizing plate 6 were placed in the view field of the left eye and the view field of the right eye of the observer, respectively, to obtain polarization glasses 4.

Both the circular polarizing plate 5 and the circular polarizing plate 6 were arranged so that their polarizing plate-side surfaces came to the observer side when the polarization glasses 4 were worn by the observer. Both the circular polarizing plate 5 and the circular polarizing plate 6 were also arranged so that the transmission axes of the polarizing plates were oriented in the horizontal direction when worn by the observer. As a result, when the polarization glasses 4 were worn by the observer, the slow axis of the first phase difference film of the circular polarizing plate 5 was in the direction of upper left−lower right. The slow axis of the first phase difference film of the circular polarizing plate 6 was in the direction of upper left−lower right. The direction of the slow axis of the λ/2 film 1 was in the horizontal direction.

### Example 1

### Manufacture of Phase Difference Film Stacked Body 1

One side of diagonally stretched ZEONOR Film (registered trademark, from ZEON Corporation, an orientation angle of 45° measured using a birefringence measuring instrument [KOBRA-WIST from Oji Scientific Instruments]) as a first phase difference film was subjected to corona discharge treatment so that the wetting index thereof was 56 dyne/cm. The corona-treated surface and the second phase difference film 1 manufactured in the Preparative Example 1 were opposed to each other and pasted by an acrylic sticky agent (SK-Dyne 2094 (from Soken Chemical & Engineering Co., Ltd., having a polymer containing ratio of 30% by weight) to which a curing agent E-XA (from Soken Chemical & Engineering Co., Ltd.) was added in proportion of five parts by weight with respect to 100 parts by weight of polymer in SK-Dyne 2094) to manufacture a phase difference film stacked body 1. The sticky layer was 20 μm in thickness.

### Example 2

### Manufacture of Phase Difference Film Stacked Body 2

A phase difference film stacked body 2 was manufactured in the same manner as in Example 1 except that the second phase difference film 2 manufactured in the Preparative Example 6 was used as a second phase difference film in place of the second phase difference film 1 manufactured in the Preparative Example 5.

### Example 3

### Manufacture of Phase Difference Film Stacked Body 3

A phase difference film stacked body 3 was manufactured in the same manner as in Example 1 except that the second phase difference film 3 manufactured in the Preparative Example 7 was used as a second phase difference film in place of the second phase difference film 1 manufactured in the Preparative Example 5.

(Evaluation)

The phase difference film stacked body 1 obtained in Example 1 was positioned on the observer-side polarizing plate of a display device (BRAVIA (registered trademark) EX700 32-inch from Sony Corporation) so that the pixel positions of the display device panel corresponded to the stripe positions of the phase difference film stacked body 1, and pasted using the PSA to obtain a display device for evaluation.

When the observer observed the resulting display device for evaluation in the vertical upright position, the transmission axis of the polarizing plate on the observer's side of the display was in the vertical direction. The slow axis of the first phase difference film of the display was in the direction of upper right−lower left. The slow axis of the anisotropic regions of the second phase difference film of the display was in the vertical direction.

An image for evaluation was input from a personal computer to the display device for evaluation, and the displayed image was visually evaluated through the polarization glasses 1. It was confirmed that a favorable three-dimensional image was obtainable.

The phase difference film stacked body 2 obtained in Example 2 was positioned on the observer-side polarizing plate of a display device (BRAVIA (registered trademark) EX700 32-inch from Sony Corporation) so that the pixel positions of the display device panel corresponded to the stripe positions of the phase difference film stacked body 2, and pasted using the PSA to obtain a display device for evaluation.

When the observer observed the resulting display device for evaluation in the vertical upright position, the transmission axis of the polarizing plate on the observer's side of the display was in the vertical direction. The slow axis of the first phase difference film of the display was in the direction of upper right−lower left. The slow axis of the anisotropic regions of the second phase difference film of the display was in the vertical direction.

An image for evaluation was input from a personal computer to the display device for evaluation, and the displayed image was visually evaluated through the polarization glasses 2. It was confirmed that a favorable three-dimensional image was obtainable.

The phase difference film stacked body 3 obtained in Example 3 was positioned on the observer-side polarizing plate of a display device (BRAVIA (registered trademark) EX700 32-inch from Sony Corporation) so that the pixel positions of the display device panel corresponded to the stripe positions of the phase difference film stacked body 3, and pasted using the PSA to obtain a display device for evaluation.

When the observer observed the resulting display device for evaluation in the vertical upright position, the transmission axis of the polarizing plate on the observer's side of the display was in the vertical direction. The slow axis of the first phase difference film of the display was in the direction of upper right−lower left. The slow axis of the anisotropic regions of the second phase difference film of the display was in the vertical direction.

An image for evaluation was input from a personal computer to the evaluation display device, and the displayed image was visually evaluated through the polarization glasses 3. It was confirmed that a favorable three-dimensional image was obtainable.

The phase difference film stacked body 2 obtained in Example 2 was positioned on the observer-side polarizing plate of a display device (BRAVIA (registered trademark) EX700 32-inch from Sony Corporation) so that the pixel positions of the display device panel corresponded to the stripe positions of the phase difference film stacked body 2, and pasted using the PSA to obtain a display device for evaluation.

When the observer observed the resulting display device for evaluation in the vertical upright position, the transmission axis of the polarizing plate on the observer's side of the display was in the vertical direction. The slow axis of the first phase difference film of the display was in the direction of upper right−lower left. The slow axis of the anisotropic regions of the second phase difference film of the display was in the vertical direction.

An image for evaluation was input from a personal computer to the evaluation display device, and the displayed image was visually evaluated through the polarization glasses 4. It was confirmed that a favorable three-dimensional image was obtainable.

### INDUSTRIAL APPLICABILITY

The phase difference film stacked body according to the present invention is used in a display device that is used for three-dimensional display.

### DESCRIPTION OF NUMERALS

1A, 3A, 4A, 5A, 7A, 8A, 9A, 10A, 11A, 12A, 13A: Second phase difference film
11, 31, 51, 71, 271, 281, 301, 311: Substrate
12, 32, 42, 272, 282, 292, 302, 312: Resin layer consisting of liquid crystal oriented resin regions and isotropic resin regions
12a, 32a, 42a, 92a, 112a, 122a, 132a, 272a, 282a, 292a, 302a, 312a: Liquid crystal oriented resin region
12b, 32b, 42b, 52b, 72b, 82b, 92b, 112b, 122b, 132b, 272b, 282b, 292b, 302b, 312b: Isotropic resin region
33, 73, 273, 303: Orientation film
52, 72, 82: Resin layer consisting of 90° twisted nematic regions and isotropic resin regions
52a, 72a, 82a: 90° twisted nematic region
91, 101: Orientation (rubbing direction)
93: Slow axis
102a, 102b: Rotating direction of polarized light
103a, 103b: 45° twisted nematic region
110, 120, 130: Roll of the second phase difference film (substrate, etc. are not shown)
14A, 15A, 16A, 17A: Apparatus for manufacturing the second phase difference film
140: Recesses and projections
151, 161, 171: UV light source
152: Light output portion
153, 163: Light shielding portion
162: Light guiding portion
164: Light guide member
167: Light intake end surface
168: Optical fiber
175: Light guiding disc
176: Light shielding disc
18A, 19A, 20A, 21A, 22A: Phase difference film stacked body
180, 190, 200, 210, 220, 270, 280, 290, 300, 310: First phase difference film
185, 195, 205, 215, 225, 275, 276, 285, 286, 295, 296, 305, 306, 315, 316: Sticky layer or adhesive layer
230, 240: Incident light into first phase difference film
250, 260: Incident light into second phase difference film
231, 241, 251, 261: Display unit
231a, 241a, 251a, 261a: Polarization axis of polarized light emitted from display device
232, 242, 252, 262: First phase difference film
232a, 242a, 252a, 262a: Slow axis of first phase difference film
233, 243, 253, 263: Second phase difference film
233a, 243a, 253a, 263a: Liquid crystal oriented resin region (first region) of second phase difference film
233b, 243b, 253b, 263b: Isotropic resin region (second region) of second phase difference film
233c, 243c: Slow axis of liquid crystal oriented resin region (first region) of second phase difference film
234, 244, 254, 264: Polarization glasses
235, 245, 255, 265: Phase difference film stacked body
236, 246, 256, 266: Three-dimensional image device
27A, 28A, 29A, 30A, 31A: Polarizing plate complex
278, 288, 298, 308, 318: Polarizing plate
320, 330, 340, 350: Incident light to phase difference film stacked body
321, 331, 341, 351: Phase difference film stacked body
322, 332: Left and right circularly polarized light images emitted from phase difference film stacked body
323, 333, 343, 353: Combination of members of polarization glasses
323L, 323R, 333L, 333R: λ/4 plate
324, 334, 344, 355: Polarization glasses
325, 335: Member of polarization glasses
326, 336, 346, 346L, 346R, 356, 356L, 356R: Polarizing plate
342, 342a, 342b, 352, 352a, 352b: Circularly polarized light
343a, 353a: Compensation layer for wavelength dispersion caused by second phase difference film
345L, 345R, 353b, 355L, 355R: λ/4 plate
345, 355: Linear polarized light

1. A phase difference film stacked body having a lengthy shape, comprising: a first phase difference film that has a uniform phase difference within a plane; and a second phase difference film that includes a plurality of regions that are patterned within a plane, the plurality of regions having different phase differences.

2. The phase difference film stacked body according to claim 1, wherein the first phase difference film has a slow axis that is not parallel to a lengthwise direction of the film.

3. The phase difference film stacked body according to claim 1, wherein the first phase difference film generates a phase difference of approximately λ/4 of light perpendicularly passing through a surface of the film.

4. The phase difference film stacked body according to claim 1, wherein the first phase difference film has a stretch axis that is not parallel to a lengthwise direction of the film.

5. The phase difference film stacked body according to claim 1, wherein the first phase difference film is a liquid crystal resin layer having a slow axis that is not parallel to a lengthwise direction of the film.

6. The phase difference film stacked body according to claim 1, wherein the second phase difference film is formed by applying a liquid crystal layer forming composition onto a substrate that has been subjected to an orientation treatment in parallel to a lengthwise direction of the film.

7. The phase difference film stacked body according to claim 1, wherein: the second phase difference film includes at least a first region and a second region having different phase differences; the first region allows incident polarized light to emit without substantially changing a polarization state thereof; and the second region allows incident polarized light to emit as light polarized in a direction orthogonal to that of the incident polarized light.

8. The phase difference film stacked body according to claim 1, wherein: the second phase difference film includes at least a first region and a second region having different phase differences; the first region allows incident polarized light to emit without substantially changing a polarization state thereof; and the second region allows incident circularly polarized light to emit as light having a substantially reversed rotational direction.

9. The phase difference film stacked body according to claim 1, wherein the first phase difference film and the second phase difference film are arranged in this order from a light source side.

10. The phase difference film stacked body according to claim 1, wherein the second phase difference film and the first phase difference film are arranged in this order from a light source side.

11. The phase difference film stacked body according to claim 1, wherein the first phase difference film and the second phase difference film are stacked via a sticky layer or an adhesive layer.

12. A polarizing plate complex comprising the phase difference film stacked body according to claim 1 and a polarizing plate.

13. A display device including a display region for the right eye and a display region for the left eye, comprising:
a cut article of the phase difference film stacked body according to claim 7,
the cut article of the phase difference film stacked body being arranged so that the first region and the second region of the phase difference film stacked body correspond to the display region for the right eye and the display region for the left eye, respectively.

14. A display device including a display region for the right eye and a display region for the left eye, comprising:
a cut article of the phase difference film stacked body according to claim 8,
the cut article of the phase difference film stacked body being arranged so that the first region and the second region of the phase difference film stacked body correspond to the display region for the right eye and the display region for the left eye, respectively.
